(19) United States
(12) Patent Application Publication
(10) Pub. No.: US 2011/0173215 A1
(43) Pub. Date: Jul. 14, 2011

(54) RETRIEVAL SYSTEM, RETRIEVAL SPACE MAP SERVER APPARATUS AND PROGRAM

(75) Inventors: Tomoyuki Yuyama, Tokyo (JP); Yoshihiko Hashimoto, Tokyo (JP); Kyoko Toyoura, Tokyo (JP); Masayuki Horiguchi, Tokyo (JP); Michael Hay, Santa Clara, CA (US); Eric Hibbard, Santa Clara, CA (US); Andrew Nielsen, Santa Clara, CA (US)

(73) Assignee: HITACHI SOLUTIONS, LTD., Tokyo (JP)

(21) Appl. No.: 13/063,802

(22) PCT Filed: May 27, 2009
(86) PCT No.: PCT/US09/45230

§ 371 Date: Mar. 14, 2011

(51) Int. Cl. G06F 7/00; G06F 17/30

(52) U.S. Cl. 707/758; 707/E17.014

(57) ABSTRACT

To provide a retrieval space map in which the ratio of unnecessary files included in the retrieval result can be decreased. One or more retrieval object spaces (retrieval objects) in which a file suitable for a retrieval purpose exists at high possibility are predefined according to the retrieval purpose under a condition containing a number of retrieval objects, and the space in which a necessary file exists at high possibility can be searched by designating the retrieval object to be suited for the retrieval purpose at the time of retrieval.

### TECHNICAL FIELD

The present invention relates to a retrieval system, a retrieval space map server apparatus and a program, and for example, a technique for providing a retrieval space with a limited retrieval range.

### BACKGROUND ART

In recent years, the digitization of information has rapidly progressed. A main subject of the digitization was once directed to store data such as an account of bank or a certificate of residence in the cities, towns and villages referred to by a computer system in the enterprise or government and municipal offices to perform the key office operations in a file or DB (Data Base).

On the other hand, at present, various kinds of papers created in the daily affairs in an organization such as an enterprise are stored as a document file, a table file, or a database at a client PC (Personal Computer) of each employee, and transmitted as an attached document of an electronic mail to the other client PC, or stored as shared information of the entire organization in a file server. And the document file stored in the file server is referred to by various employees, and often copied to the client PC and updated.

In this way, a large amount of document file, table file, electronic mail, database, each record stored in the database, and a program (hereinafter generically referred to as a “file”) are distributed and stored in various computers, so that a number of duplicate or similar files exist within the organization. Also, the storage capacity of each computer continuously increases.

On the other hand, within the organization, there are many cases where it is desired to refer to a file for which storage location is unknown, for example, a case of needing a file created before by the employee who already retired. In such cases, a method for retrieving the file containing a designated keyword by designating the keyword or file creator that should be contained in the file is widely used.

However, if an attempt is made to retrieve the file from all the computers within the organization, many unnecessary files in which there is by chance a match of keyword may be retrieved, whereby it is often required to find out the truly necessary file by checking the contents of the file of retrieval result one by one.

In this way, a great number of files are created, with a retrievable range extended, whereby there is higher possibility that the necessary file exists somewhere, but conversely, it is more difficult to find the necessary file. As a result of the increased storage capacity of the computer, it is difficult to file out the necessary file, even when the retrieval object is limited to one computer. To solve such a problem, a technique for limiting the file to be retrieved is known in Patent Document 1, for example.

In Patent Document 1, a method for predicting the number of retrievals in retrieving each database under a designated retrieval condition by firstly making a sampling survey (preliminary retrieval) for each retrievable database using a predetermined keyword, and deciding the database of retrieval object so that the number of retrievals may be less than or equal to a predetermined value, based on this prediction, that is, a method for dynamically deciding the retrieval object was disclosed.
[Patent Document 1] JP Patent Publication (Kokai) No. 2000-99514

### DISCLOSURE OF THE INVENTION

### Problems to be Solved by the Invention

However, with the technique as disclosed in Patent Document 1, it is possible to refine a search by narrowing the retrieval objects, but it is not considered whether or not a necessary file is covered in the refined search.

Reviewing the essence of the problem herein, the existence itself of a number of retrieval results is not a problem, but rather desirable. Generally, the retrieval results include more unnecessary files than the necessary file, resulting in a problem that if the number of retrieval results is greater, many unnecessary files are included in the retrieval results. The operator having a high retrieval technique can appropriately refine the search by changing a combination of keywords, or designating a classification code, but most retrievers do not have such retrieval technique. Also, as the above retrieval technique is higher in the level, a so-called Tacit Knowing occurs, whereby it is difficult that the technique itself is generally expressed in the words or sentences. On the other hand, if the retrieval purpose is known in advance, the operator having high level of retrieval technique may prepare a retrieval condition in which the noise is removed as much as possible and the general retriever may perform the retrieval within this prepared retrieval condition. That is, it is an appropriate approach to solving the problem that the ratio of unnecessary files included in the retrieval result is decreased, irrespective of whether the retrieval technique is high or low.

The invention has been achieved in the light of these circumstances, and it is an object of the invention to provide a retrieval technique for decreasing the ratio of unnecessary files included in the retrieval result by searching a space with high possibility that a necessary file exists under a situation containing a number of retrieval objects.

### Means for Solving the Problems

In order to accomplish the above object, in a retrieval technique according to the invention, one or more retrieval object spaces (retrieval objects) with high possibility that there is a file suitable for a retrieval purpose are defined in advance according to the retrieval purpose and the retrieval object is limited to suit the retrieval purpose at the time of retrieval.

That is, a retrieval system according to the invention comprises a client terminal, a retrieval space map processing section for providing a retrieval space from a plurality of preset retrieval spaces, the retrieval space defining at least a part of the entire retrieval range, and a retrieval processing section for searching a range defined by the retrieval space in accordance with a retrieval instruction from the client terminal. And the retrieval space map processing section transmits information of a selectable retrieval space to the client terminal by designating the retrieval space that can be searched by the log in user from the plurality of preset retrieval spaces, based on log in information from the client terminal. On the other hand, the retrieval processing section performs the retrieval in the retrieval space selected at the client terminal in response to a retrieval instruction. The retrieval space is defined by limiting the entire retrieval range with at least one of pieces of information including a retrieval purpose, an attribute of retrieval object, a reference authority and a creation period.

The retrieval system further comprises a report file storage section for storing a report file describing the retrieval result in the past, corresponding to each of the plurality of retrieval spaces. And the retrieval space map processing section can present the report file corresponding to the selected retrieval space and the retrieval result at the present time in the selected retrieval space to the client terminal by referring to the report file storage means.

Also, the retrieval space map processing section generates a retrieval display screen that can display the retrieval result by switching between the retrieval result at the present time in the selected retrieval space and the retrieval result of the file report and transmits it to the client terminal. On the other hand, the client terminal displays the retrieval display screen on the screen of a display device, and displays the retrieval result by switching between the retrieval result at the present time and the retrieval result of the file report in response to an instruction of the user.

The other features of the invention will be apparent from the best mode for carrying out the invention in the following and the accompanying drawings.

### Advantages of the Invention

With the invention, it is possible to provide a retrieval space map apparatus in which one or more retrieval object spaces (retrieval objects) with high possibility that there is a file suitable for a retrieval purpose are defined in advance according to the retrieval purpose under a condition where there are a number of retrieval objects and the ratio of unnecessary files included in the retrieval result can be decreased by designating the retrieval object suitable for the retrieval purpose at the time of retrieval and searching the space with high possibility that a necessary file exists.

### BRIEF DESCRIPTION OF THE DRAWINGS

FIG. 1 is a system block diagram of a retrieval space mapping system according to a first embodiment of the present invention.

FIG. 2 is a data organization view of a retrieval space definition file.

FIG. 3 is a conceptual diagram of a retrieval space.

FIG. 4 is a conceptual diagram of the retrieval space.

FIG. 5 is a data organization view of a report file.

FIG. 6 is a data organization view of retrieval management data.

FIG. 7 is a flowchart showing the operation of WEB page display means for file retrieval.

FIG. 8 is a view exemplifying a log in screen.

FIG. 9 is a view exemplifying a retrieval space selection screen.

FIG. 10 is a view exemplifying a retrieval screen.

FIG. 11 is a view exemplifying the retrieval screen (file retrieval result).

FIG. 12 is a view exemplifying a display screen (file display result).

FIG. 13 is a view exemplifying a report creation screen.

FIG. 14 is a view exemplifying a retrieval screen (report retrieval result).

FIG. 15 is a view exemplifying a display screen (report display result).

FIG. 16 is a flowchart showing the operation of retrieval space map means during a log in process.

FIG. 17 is a flowchart showing the operation of the retrieval space map means during a retrieval space selection process.

FIG. 18 is a flowchart showing the operation of the retrieval space map means during a retrieval process.

FIG. 19 is a flowchart showing the operation of the retrieval space map means during a retrieval result acquisition process.

FIG. 20 is a flowchart showing the operation of the retrieval space map means during a report creation process.

FIG. 21 is a flowchart showing the operation of the retrieval space map means during a display process.

FIG. 22 is a flowchart showing the operation of the retrieval space map means during a log out process.

FIG. 23 is a system block diagram of a retrieval space mapping system according to a second embodiment of the invention.

FIG. 24 is a system block diagram of a retrieval space mapping system according to a third embodiment of the invention.

### DESCRIPTION OF SYMBOLS

1 . . . retrieval space map server, 11 . . . WEB page sending means, 12 . . . retrieval space map means, 13 . . . retrieval management data, 16 . . . storage device, 17 . . . retrieval space definition file, 18 . . . report file, 2 . . . client, 21 . . . WEB page display means, 26 . . . input device, 27 . . . display device, 28 . . . storage device, 3 . . . retrieval server, 31, 31a, 31b retrieval means, 4 . . . file server, 46 . . . storage device, 47 . . . retrieval object file, 9 . . . LAN, 9a . . . internet

### BEST MODE FOR CARRYING OUT THE INVENTION

The present invention is concerned with a retrieval space mapping system (retrieval system) that can perform the retrieval in a virtual search space (VSS: Virtual Search Space) by logging in to the virtual search space, in which a range of retrieval object is defined beforehand as the virtual search space according to the retrieval purpose.

The embodiments of the invention will be described below with reference to the accompanying drawings. It should be noted that this embodiment is only one example for implementing the invention, and does not limit the technical range of the invention. The same reference numerals are attached to the common parts throughout the drawings.

### (1) First Embodiment

### <Configuration and Function of Retrieval Space Mapping System>

A retrieval space mapping system 100 comprises a retrieval space map server 1, a retrieval server 3, a file server 4, and a client 2 (hereinafter referred to as “server or the like”). And the devices are interconnected to be communicable with each other via a wire or wireless communication line such as a LAN (Local Area Network) 9 in this system.

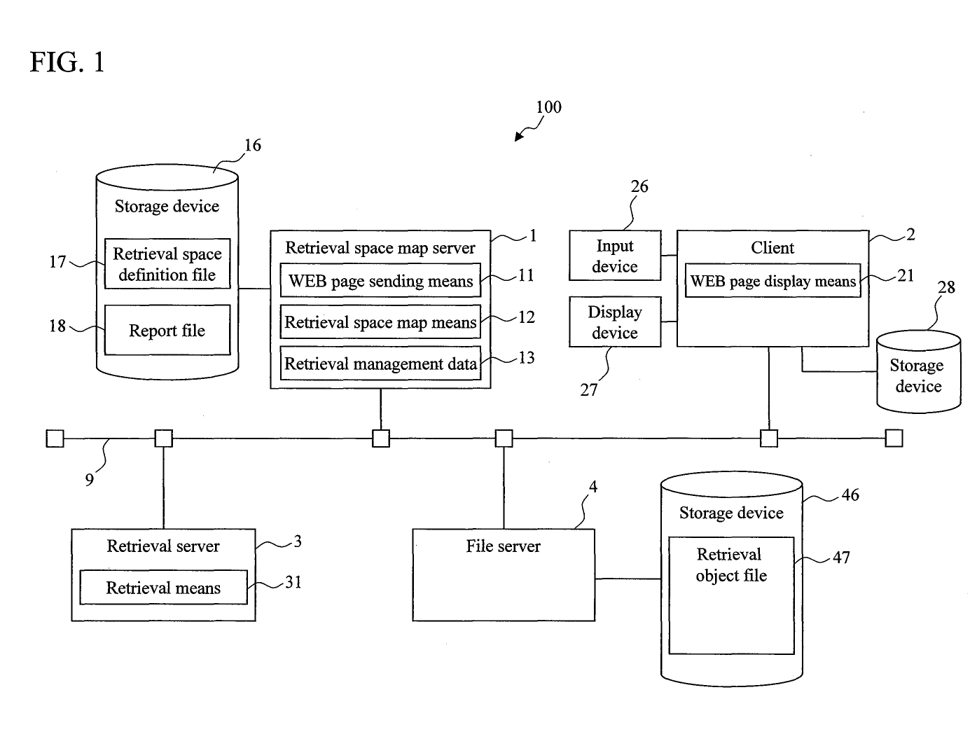

In FIG. 1, though the server or the like is connected to be communicable with each other via the LAN 9, a connection method is not limited to the LAN, but may be a WAN (Wide Area Network) or internet.

Also, though the server or the like is connected on the same LAN segment in FIG. 1, this configuration is only one example, but any other configuration may be taken.

Further, though the retrieval space map server 1, the retrieval server 3, the file server 4 and the client 2 exist one for each in FIG. 1, two or more servers or clients may exist.

Also, it is unnecessary that the retrieval space map server 1, the retrieval server 3, the file server 4 and the client 2 are different devices, but the functions of the retrieval space map server 1, the retrieval server 3, the file server 4 and the client 2 may be realized by one device, for example.

With the above configuration, the client 2 sends a file retrieval request via the retrieval space map server 1 and the retrieval server 3 to the file server 4, and the file server 4 sends file retrieval result data, namely, a file name of a file matched with a retrieval condition, a URL or the like (hereinafter abbreviated as “retrieval result data”) via the retrieval server 3 and the retrieval space map server 1 to the client 2.

As described in the “Background Art” in the invention, all the digital information stored in an information processing apparatus, such as a document file, a table file, an electronic mail, a database, each record stored in the database, a program and so on is generically called a “file”.

### <Configuration and Function of Client (Terminal Unit)>

The client 2 is composed of a device such as a PC, and comprises an input device 26, a display device 27, and a storage device 28, which are connected to be communicable. The input device 26 is a unit such as a keyboard or a mouse, in which the operator (user) of the client 2 can designate a process for the client 2 to perform by operating the input device 26. That is, the input device 26 functions as input means of the client 2.

The display device 27 is composed of a liquid crystal display or printer, and displays or prints out the result of the process performed by the client 2. That is, the display device 27 functions as display means and output means of the client 2. The storage device 28 is a unit such as a magnetic disk, built in the client 2 or externally connected. The storage device 28 and a main internal memory, not shown, of the client 2 function as storage means of the client 2.

Also, the client 2 comprises a CPU (Central Processing Unit), not shown, and the main internal memory, in which the CPU performs various kinds of processing by loading a program such as a WEB browser, not shown, stored in the storage device 28 into the main internal memory and executing an instruction code. Since the techniques involving execution of the program are well known, the description is given as if the hardware exists for various kinds of program such as WEB page display means 21 for a WEB browser, and as if each means performs the process, to avoid complex explanation for the execution of the program in the following explanation and drawings. Actually, each means (e.g., WEB page display means 21) may be composed of an electronic device or a combination of electronic device and firmware.

The WEB page display means 21, which is the WEB browser as described above, sends a URL (Uniform Resource Locator) or the like inputted with the input device 26 by the operator of the client 2 to the retrieval space map server 1, and displays a WEB page composed of an HTML (HyperText Markup Language) sent from the retrieval space map server 1 on the display device 27.

Herein, since the server or the like is assigned an IP address for uniquely specifying the location on the communication line or an identification name (hereinafter simply referred to as an “identifier”) corresponding to the IP address, the client 2 sends the IP address of the client 2 itself in addition to the URL or the like to the IP address of the retrieval space map server 1, for example, to designate where the retrieval space map server 1 sends the WEB page.

### <Configuration and Function of Retrieval Space Map Server 1>

The retrieval space map server 1 is composed of a device such as a PC, and connected to be communicable with the storage device 16. The storage device 16 is a unit such as a magnetic disk, built in the retrieval space map server 1 or externally connected. The storage device 16 and a main internal memory, not shown, of the retrieval space map server 1 function as storage means of the retrieval space map server 1.

A retrieval space definition file 17 and a report file 18 are stored in the storage device 16. Also, the retrieval space definition file 17 stores one or more retrieval spaces (i.e., a file path or file type of a file of retrieval object) in accordance with the retrieval purposes (a retrieval purpose, an attribute (e.g., doc or txt) of the file of retrieval object, a reference authority of the operator (user), a creation period of retrieval object, and a specific keyword). That is, the retrieval space is predefined by limiting data in the entire retrieval range with information such as the retrieval purpose (at least one piece of information of the above information). The retrieval space map server 1 sends a list of retrieval space to the WEB page display means 21 and the WEB page display means 21 displays the received list of retrieval space on the display device 27, as will be described later. And the operator of the client 2 selects the retrieval space matched with the retrieval purposes from the displayed list of retrieval space. Retrieval result data corresponding to the retrieval space is stored in the report file 18.

The retrieval space can be defined according to the retrieval purposes (including a retrieval purpose, a file attribute, a reference authority, and a creation period), such as the space for retrieving the file regarding a specific development project, as will be described later. And the operator of the client 2 retrieve the file stored in the retrieval space using a retrieval condition such as a keyword to select the file matched with the purposes of the retrieval space from the retrieval result and store it associated with the retrieval space in the report file 18. That is, the desired file from the retrieval space is incorporated into the report file 18.

As a result of the above operation, the files matched with the purposes of the retrieval space are gradually accumulated in the report file 18. Accordingly, the operator of the client 2 retrieve both the retrieval space and the report file 18 to display the respective retrieval results on the different screens, and can obtain the retrieval result with less noise, including the file incorporated by the operator of the other client 2 from the report file 18, and newly find out the file with relatively large noise but not yet incorporated into the report file 18 from the retrieval space on the other side.

The retrieval space map server 1 comprises WEB page sending means 11 (WEB server) and retrieval space map means 12 (retrieval space map program). The retrieval space map server 1, like the client 2, comprises a CPU and a main internal memory, not shown, in which the CPU performs various kinds of processing by loading a program such as a WEB server, not shown, stored in the storage device 16 into the main internal memory and executing the instruction code. Also, the retrieval management data 13 is stored in the main internal memory.

The WEB page sending means 11 is composed of a WEB server such as Apache (registered trademark), for example, and creates a WEB page composed of the HTTP by referring to the URL or the like received from the WEB page display means 21 and sends it to the WEB page display means 21. Also, the WEB page sending means 11 starts the retrieval space map means 12, if the URL or the like received from the WEB page display means 21 is a predetermined value.

The retrieval space map means 12 creates the WEB page composed of the HTTP, such as a log in screen, a retrieval space selection screen or a retrieval screen and delivers it to the WEB page sending means 11, and the WEB page sending means 11 sends the delivered WEB page to the client 2 to display it on the WEB page display means 21.

The retrieval management data 13 stores, for each client 2, data for identifying the operator of the client 2, data indicating the retrieval range in which the retrieval space map means 12 should have the retrieval object, and retrieval result data, as will be described later.

The operator of the client 2 firstly logs in to the retrieval space map means 12, designates the retrieval space of retrieval object, performs a retrieval process for the designated retrieval space, and logs out after ending the necessary operation, as will be described later. And the operator of the client 2 inputs a user ID for identifying the operator at the time of log in, but does not input the user ID thereafter, whereby it is necessary to store the user ID anywhere until the log out. Similarly, it is necessary to store data for identifying the retrieval space of retrieval object designated by the operator of the client 2 anywhere until the log out. The retrieval result data is also treated in the same way.

Thus, in the first embodiment, these data are included in the retrieval management data 13. Any other method than storing data in the retrieval management data 13, for example, a method for sending or receiving the necessary data between the WEB page display means 21 and the WEB page sending means 11 timely, using an HTTP (Hypertext Transfer Protocol) cookie, may be possible.

The retrieval space map means 12 sends data for designating the retrieval keyword, file of retrieval object, folder and DB (Data Base) (all of these are called “file” as already described) in the invention to the retrieval server 3 in creating the retrieval screen, and sets up the retrieval result data received from the retrieval server 3 on the retrieval screen.

Since the server or the like is assigned the IP address or identifier for uniquely specifying the location on the communication line, as previously described, the retrieval space map means 12 sends the IP address of the retrieval space map server 1 in addition to each data to the IP address of the retrieval server 3 to designate where the retrieval server 3 should send the retrieval result data, for example.

### <Configuration and Function of Retrieval Server 3>

The retrieval server 3 is composed of a device such as a PC, and comprises retrieval means 31 (retrieval program). The retrieval server 3, like the client 2, comprises a CPU and a main internal memory, though not shown, in which the CPU performs various kinds of processing by loading a program such as a retrieval program stored in the storage device into the main internal memory and executing the instruction code, though not shown.

The retrieval means 31 retrieves a file stored in the file server 4, using a retrieval keyword received from the retrieval space map means 12, and sends the retrieval result data to the retrieval space map means 12. Though the retrieval object of the retrieval means 31 is the file stored in the file server 4 in the first embodiment, the retrieval means 31 may be configured to treat the file stored in the retrieval space map server 1 or the client 2 as the retrieval object.

Since the retrieval of the file by such retrieval means 31 is a well known technique, how the retrieval means 31 specifically retrieves the file is not described here in detail, although the retrieval means 31 may perform the retrieval by receiving a file retrieval command (e.g., “SearchFile Keyword=‘projectX’”: retrieving the file including the keyword ‘projectX’, or “Filetype=‘doc’ or ‘txt’”: retrieving the file with file extension ‘doc’ or ‘txt’) from the retrieval space map means 12, for example. That is, the retrieval space map means 12 may create a command that can be understood by the retrieval means 31 and send it to the retrieval means 31. And the file server 4 may be provided with a retrieval agent (program), the retrieval means 31 may send the retrieval command to the retrieval agent, and the retrieval agent may send the retrieval result data to the retrieval means 31. Also, on this occasion, the retrieval means 31 may send the retrieval command to a plurality of retrieval agents in the file server 4 in parallel, receive the retrieval result data from the retrieval agents in parallel, and unify the duplicate retrieval result data into one, thereby merging the retrieval result data and sending the merged data to the retrieval space map means 12. The term “parallel” as used herein means performing the file retrieval by each retrieval agent independently by creating a thread corresponding to each of the plurality of retrieval agents in the file server 4 to send the retrieval command to each retrieval agent and receive the retrieval result data from each retrieval agent, for example, rather than sending the retrieval command to one retrieval agent in the file server 4, waiting until the retrieval result data is received from the retrieval agent, and sending the retrieval command to another retrieval agent in the file server 4 after receiving.

Since the server or the like is assigned the IP address or identifier for uniquely specifying the location on the communication line, as previously described, the retrieval means 31 sends the IP address of the retrieval server 3 in addition to the retrieval keyword to the IP address of the file server 4 to designate where the file server 4 should send the retrieval result data, for example.

### <Configuration and Function of File Server 4>

The file server 4 is composed of a device such as a PC, and connected to be communicable with a storage device 46. The storage device 46 is a unit such as a magnetic disk, built in the file server 4 or externally connected. Also, the storage device 46 and a main internal memory, not shown, of the file server 4 function as storage means of the file server 4.

Though only one storage device 46 is shown in FIG. 1, a plurality of storage devices 46 composed of various kinds of units, such as a magnetic tape, a magnetic disk, and an optical disk, may be connected. And for example, when the retrieval means 31 retrieves the file stored in the file server 4, the retrieval means 31 can designate the retrieval object on the storage device 46 with a logical volume name or a file path, as well known. The storage device 16 or storage device 28, like the storage device 46, may be composed of various kinds of units, in which the file can be designated with the logical name or file path.

A retrieval object file 47 is stored in the storage device 46. Herein, the retrieval object file 47 does not indicate a specific file stored in the storage device 46 but indicates all the files that can become the retrieval object. Accordingly, the retrieval object file 47 may be all the files stored in the storage device 46, or all the files except for the top secret file such as a system log. The file server 4 receives a retrieval command from the retrieval means 31, retrieves the file matched with the retrieval condition including the retrieval keyword from the files stored in the retrieval object file 47, and sends the retrieval result data to the retrieval means 31.

### <Organization of Retrieval Space Definition File>

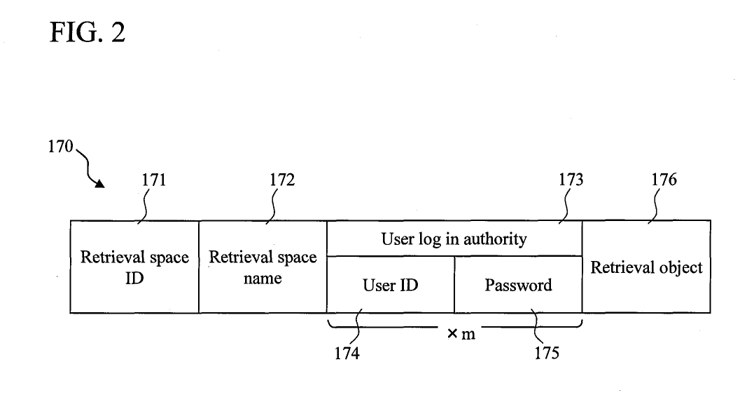

FIG. 2 is a data organization view of the retrieval space definition file 17. The retrieval space definition file 17 is composed of one or more retrieval space definition records 170. Each retrieval space definition record 170 stores a retrieval space name indicating the retrieval purpose, and a file path or file type of the file of retrieval object.

More specifically, the retrieval space definition record 170 is composed of the data items of a retrieval space ID 171, a retrieval space name 172, a user ID 174, a password 175, and a retrieval object 176. The user ID 174 and the password 175 are generically called as a user log in authority 173, and set by the number (m) of users having the log in authority in the retrieval space ID 171.

The retrieval space ID 171 is set to the ID (identifier) for identifying the retrieval space for the retrieval space map means 12. Though not shown, the retrieval space map server 1 has a retrieval space definition file creation/update program.

Also, the operator of the retrieval space map server 1 starts the retrieval space definition file creation/update program by operating the input device such as a keyboard or mouse connected to the retrieval space map server 1, and creates, changes or deletes the retrieval space definition record 170 by inputting each data, though not shown. And the retrieval space ID 171 is set to a value, for example, “VSS1”, inputted by the operator of the retrieval space map server 1.

The retrieval space name 172 is set to the name of the retrieval space corresponding to the retrieval space ID 171. More specifically, a value that the operator of the retrieval space map server 1 inputs by running the retrieval space definition file creation/update program, for example, “development project X” is set. The name set in the retrieval space name 172 is displayed on a retrieval space list screen, as will be described later, whereby the operator of the client 2 can know that the retrieval space ID 171 “VSS1” is the space for retrieving the file regarding the “development project X”, namely, the purpose of the retrieval space. Besides the retrieval space name 172, a data item “retrieval purpose” may be provided, and the retrieval purpose (e.g., “retrieving technical data regarding the development project X”) with the retrieval space ID 171 may be set. In this way, the operator of the client 2 can select the appropriate retrieval space more easily, seeing the retrieval purpose displayed on the retrieval space list screen.

The user ID 174 is set to the ID for specifying the user who can perform the retrieval with the retrieval space ID 171, namely, the user who can log in to the retrieval space ID 171. More specifically, a value, for example, “usr1”, that the operator of the retrieval space map server 1 inputs by running the retrieval space definition file creation/update program is set.

The password 175 is set to the password for the corresponding user ID 174 to input in logging in to the retrieval space ID 171.

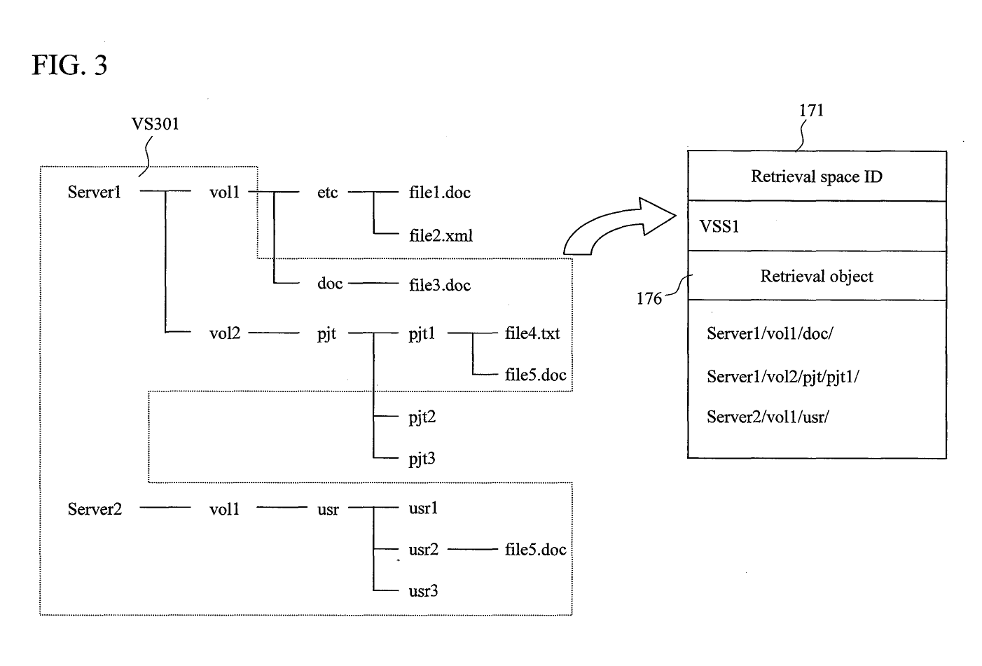

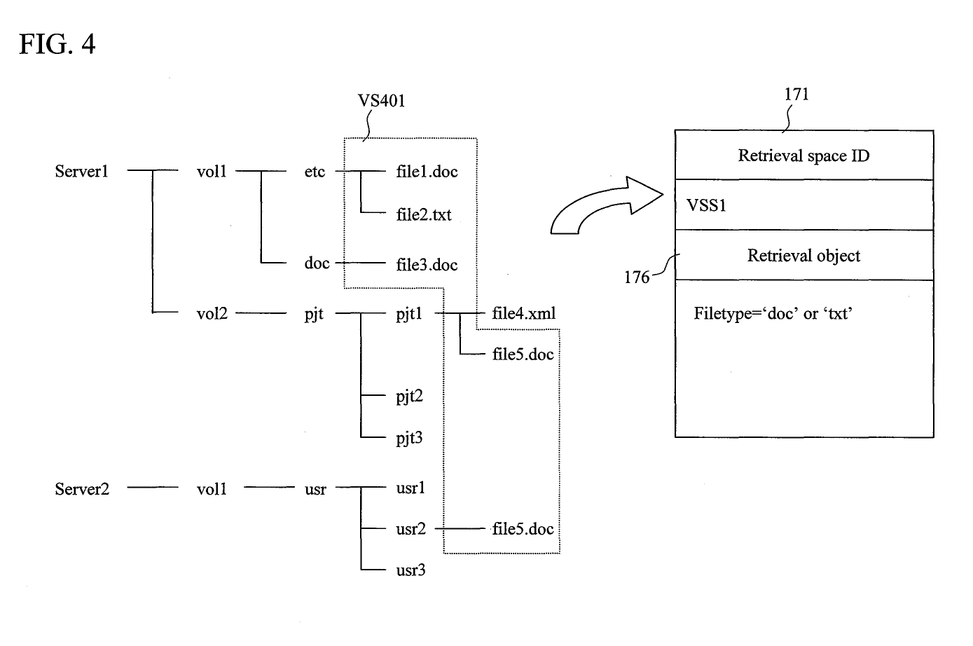

The retrieval object 176 is set to the file path, file type or keyword of retrieval object in the retrieval space ID 171. Referring to FIGS. 3 and 4, the set content of the retrieval object 176 will be described below in detail.

### <Concept of Retrieval Space>

FIG. 3 is a view for explaining the retrieval space. In the configuration of the file server 4 as shown herein, the identifier of a certain file server 4 is “Server1”, and the identifier of another file server 4 is “Server2”. The “Server1” is composed of two logical volumes, in which each logical volume can be uniquely identified with the name of “vol1” or “vol2”. The “Server2” is composed of one logical volume that can be uniquely identified with the name of “vol1”.

In the vol1” and “vol2” of “Server1” and the “vol1” of “Server2”, there are file paths consisting of folders and files as shown. For example, two folders of “etc” and “doc” exist in the “vol1” of “Server1”, in which the “etc” folder has two files of “file1.doc” and “file2.xml”, and the “doc” folder has one file of “file3.doc”. Similarly, one folder of “pjt” exists in the “vol2” of “Server1”, the “pjt” folder has three folders of “pjt1”, “pjt2” and “pjt3”, and the “pjt1” folder has two files of “file4.txt” and “file5.doc”. Also, one folder of “usr” exists in the “vol1” of “Server2”, the “usr” folder has three folders of “usr1”, “usr2” and “usr3”, and the “usr2” folder has one file of “file5.doc”.

Among the above logical volumes and files paths of the file server 4, for example, if any file pertinent to the development project X exists within the dotted lines indicated by “VS301” in FIG. 3, the retrieval space definition record 170 in which the retrieval space ID 171 is “VSS1” may be created and “Server1/vol1/doc/”, “Server1/vol2/pjt/pjt1/” and “Server2/vol1/usr/” may be set to the retrieval object 176 of the applicable record. If such space definition record 170 is created and the operator of the client 2 logs in to the “VSS1”, the retrieval space map means 12 instructs the retrieval means 31 to treat only the files within the “Server1/vol1/doc/”, “Server1/vol2/pjt/pjt1” and “Server2/vol1/usr/”, namely, only the files within the VS301 in FIG. 3 as the retrieval object.

Though in this example, the retrieval object 176 is set to the identifier of the file server 4, the logical volume and the file path, the server or the like other than the file server 4, for example, the retrieval space map server 1, can be also set as the retrieval object. Also, the set identifier of the server or the like, logical volume and file path are not only the retrieval object, but also the “Server1/vol1/doc/” is the retrieval object if the “ALLOW Server1/vol1/doc/” is set, or the “Server1/vol1/doc/” is the retrieval out-of-object if the “DENY Server1/vol1/doc/” is set, for example, whereby the retrieval object and the retrieval out-of-object may be combined and designated.

Also, the retrieval object 176 may be set to the file path, file type or keyword of retrieval object, or a combination thereof.

FIG. 4 is a conceptual view for explaining another example of the retrieval space, in which the file type is designated for the retrieval object 176. In FIG. 4, the organization of the file server 4, the logical volume and the file path is the same as in FIG. 3, and a document file and a text file are the retrieval object, in which the file retrieval location cannot be specified. In this case, data indicating the file types of the document file and the text file, for example, the file extensions “doc” and “txt” may be set to the retrieval object 176. In this way, for example, the retrieval means 31 having no retrieval function with the file extension (i.e., retrieval means 31 in which the retrieval object cannot be designated by the file extension) performs the retrieval without designation of the file extension, and the retrieval space map means 12 can select the retrieval file with the file extension “doc” or “txt” from among the retrieval result data sent from the retrieval means 31.

On the other hand, data indicating the file type is not simply set, but a part of the file retrieval command designating the retrieval object such as “Filetype=‘doc’ or ‘txt’”, for example, may be directly set. In this way, the retrieval means 31 having the retrieval function with the file extension (i.e., the retrieval means 31 that can designate the retrieval object with the file extension) can perform the retrieval by creating the file retrieval command, directly using data set in the retrieval object 176. Further, the retrieval object can be set by easily combining a plurality of retrieval conditions, for example, “SearchFile (Keyword=‘projectX’ and (Filetype=‘doc’ or ‘txt’))” (i.e., retrieving the file including the keyword ‘projectX’ and with the file extension ‘doc’ or ‘txt’).

The operator of the retrieval space map server 1 can create the retrieval space definition record 170 from which the noise is removed as much as possible in accordance with the retrieval purpose of “retrieving the file pertinent to the development project X” in the above way.

### <Data Organization of Report File>

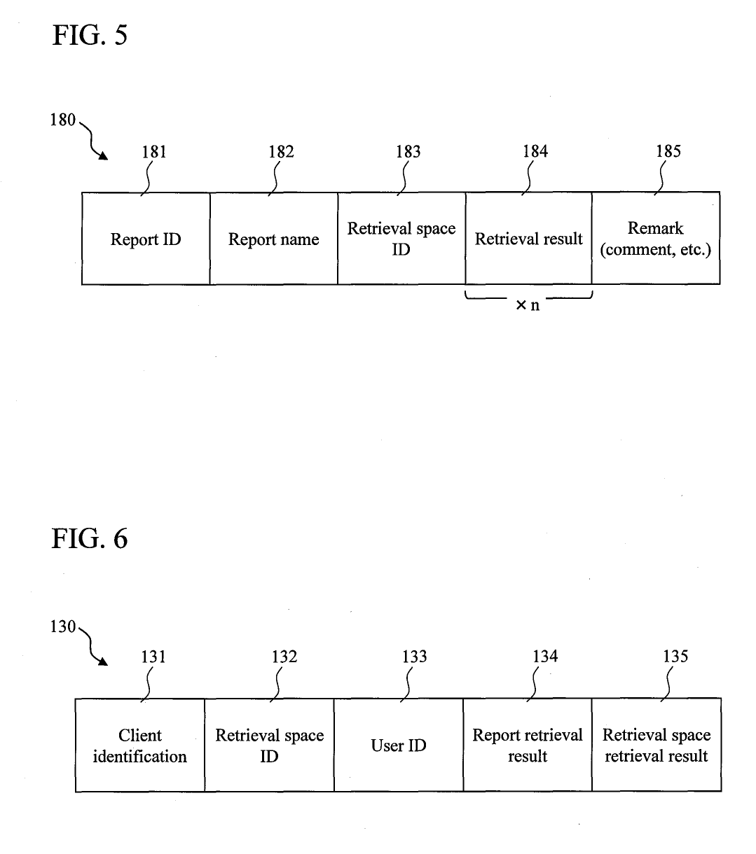

FIG. 5 is a view showing the data organization of the report file 18. The report file 18 is composed of one or more report records 180.

The report record 180 is the record storing the retrieval result data (retrieval result attained in the past for the applicable retrieval space) of the retrieval space map means 12, in which the retrieval result data that the retrieval space map means 12 receives from the retrieval means 31 is stored therein. More correctly, the retrieval result data that the retrieval space map means 12 receives from the retrieval means 31 is displayed on the display device 27, whereby the operator of the client 2 selects the retrieval result to be stored in the report record 180 from the displayed retrieval result data, creating the report record 180, as will be described later.

The report record 180 is composed of data items of a report ID 181, a report name 182, a retrieval space ID 183, and a retrieval result 184. One or more (n) retrieval results 184 may exist.

The report ID 181 is set to the ID capable of uniquely identifying the report record 180 such as “report01”. For example, a counter with the initial value of 0 is stored in the storage device 16, and every time the report record 180 is created, the counter value is incremented by 1, whereby “report” with the counter value is set to the report ID 181, though not shown.

Also, the report name 182 is set to the name of the report record 180, such as “development plan sheet”.

The retrieval space ID 183 is set to the retrieval space ID 171 of the retrieval space of retrieval object, such as “VSS1”, for example.

The retrieval result 184 is set to the file name and URL or the like of the file that the retrieval space map means 12 receives as retrieval result data from the retrieval means 31. For example, the retrieval result can be directly displayed as a part of the WEB page by setting data including the file name and URL or the like in the HTML format.

Further, a comment by the system administrator or the operator of the client 2 can be inputted into a remarks column 185.

### <Organization of Retrieval Management Data>

FIG. 6 is a view showing the data organization of the retrieval management data 13. The retrieval management data 13 is composed of zero or more retrieval management records 130.

The retrieval management record 130 is the record for the retrieval space map means 12 to specify the operator of the client 2 and the retrieval space for a period from the time when the operator of the client 2 logs in to the retrieval space map means 12 to the time when the operator logs out. If the operator of the client 2 logs in to the retrieval space map means 12, the retrieval space map means 12 creates the retrieval management record 130 for the concerned client 2, and if the operator of the client 2 logs out of the retrieval space map means 12, the retrieval space map means 12 deletes the retrieval management record 130 for the concerned client 2, as will be described later. Accordingly, if any operator of the client 2 does not log in to the retrieval space map means 12, the retrieval management record 130 does not exist (in other words, there is null retrieval management record).

The retrieval management record 130 is composed of data items of a client identification 131, a retrieval space ID 132, a user ID 133, a report retrieval result 134, and a retrieval space retrieval result 135.

The client identification 131 is set to data capable of uniquely identifying the client 2 such as an IP address of the client 2.

Also, the retrieval space ID 132 is set to the retrieval space ID 171 of the retrieval space to which the operator of the client 2 logs in, such as “VSS1”, for example.

The user ID 133 is set to the user ID of the operator who logs in to the concerned retrieval space ID 132.

Further, the report retrieval result 134 is set to the retrieval result data of retrieving the report file 18, namely, the report ID 181 or report name 182 of the report record 180 matched with the retrieval condition.

Also, the retrieval space retrieval result 135 is set to the retrieval result data of retrieving the retrieval space, namely, the file name and URL or the like of the file matched with the retrieval condition.

Thus, the configuration and function of the retrieval space mapping system according to the first embodiment, as well as the organization of each file and data have been described above. The operation of the retrieval space mapping system according to the first embodiment will be described below.

### <Operation Contents of the Retrieval Space Mapping System>

i) Processing Operation Before Log in

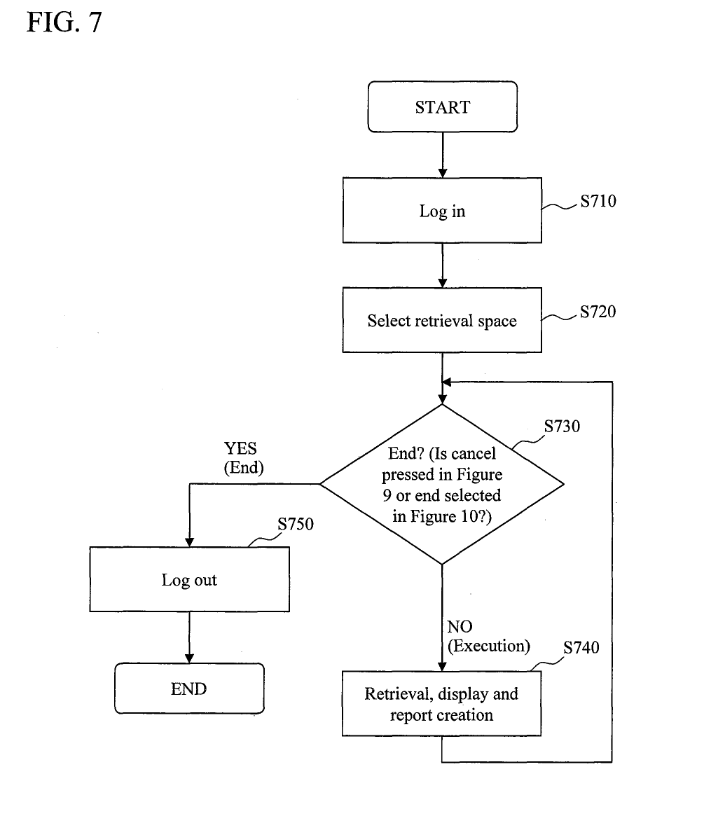

First of all, a process before log in at the client 2 will be described below before explanation of a flowchart of FIG. 7.

If the operator of the client 2 starts the WEB page display means 21 by operating the input device 26, the WEB page display means 21 displays a WEB perusal screen on the display device 27. And if the operator of the client 2 inputs a predetermined URL (e.g., “http://vsserver.somecompany.com/vssearch/login.html”) into a URL input/display field of the WEB perusal screen by operating the input device 26, the WEB page display means 21 sends the input URL to the retrieval space map server 1.

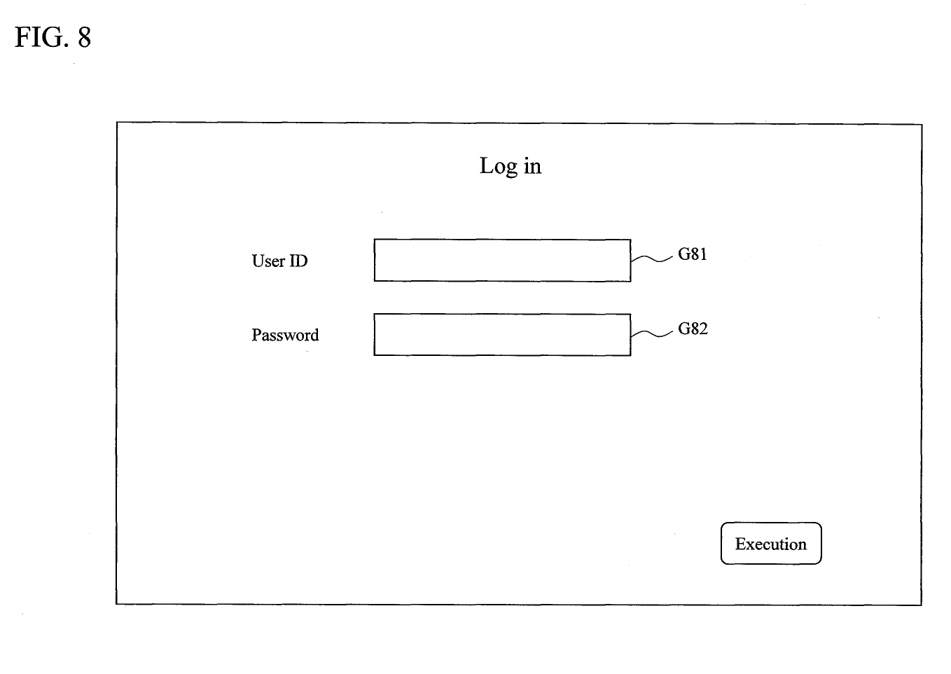

The WEB page sending means 11 of the retrieval space map server 1 receives the input URL, and sends a WEB page for a log in screen to the WEB display means 21. The WEB page display means 21 displays the received WEB page as the log in screen on the display device 27. A display example of the log in screen is shown in FIG. 8. Though the fields provided for the display screen of the normal WEB browser such as the URL input/display field or a “return” button, are not displayed in the following screen display examples, including FIG. 8, these fields are also naturally displayed on the screen.

ii) Processing Operation at the Client 2

FIG. 7 is a flowchart for explaining the operation of the WEB page display means 21 at the client 2 involved in the file retrieval.

(a) Step S710

The WEB page display means 21 accepts a log in from the operator (step S710). More particularly, first of all, the operator of the client 2 inputs a user ID (G81) and a password (G82) on the log in screen by operating the input device 26, and clicks an execution button on the lower part of the log in screen.

Then, the WEB page display means 21 sends the inputted user ID and password together with a log in processing request to the WEB page sending means 11. Various methods for sending the log in processing request are well known, including a method for sending a predetermined URL (e.g., “http://vsserver.somecompany.com/vssearch/cgi/login.cgi”) in which the CGI (Common Gateway Interface) to perform the log in process is designated to the WEB page sending means 11, whereby it is necessary to select and use the method from among those methods.

The same method can be used for a retrieval space selection processing request as will be described later. In this case, for the retrieval space selection processing request, for example, the retrieval space map means 12 can perform a retrieval space selection process, not the log in process, by sending a predetermined URL (e.g., “http://vsserver.somecompany.com/vssearch/cgi/vsselect.cgi”) in which the CGI different from the log in processing request is designated to the WEB page sending means 11. In such a case, a retrieval space map program (retrieval space map means 12) is composed of a plurality of CGIs. Further, it is possible to append a parameter (“function=login” in this example) to the designation of CGI, such as “http://vsserver.somecompany.com/vssearch/cgi/vssearch.cgi&function=login”, for example. In this way, it is possible to perform a different process for one CGI depending on the parameter.

(b) Step S720

Next, the WEB page display means 21 performs the retrieval space selection process (step S720). That is, first of all, the WEB page display means 21 displays the WEB page received from the retrieval space map means 12 on the display device 27. If the WEB page display means 21 receives a WEB page of an error screen from the retrieval space map means 12, the error screen is displayed on the display device 27, whereby it is necessary that the operator of the client 2 resolves a cause of error and performs the log in operation again. In this case, the WEB page display means 21 performs step S710 again. If the WEB page display means 21 receives a WEB page of a retrieval screen from the retrieval space map means 12, the retrieval screen is displayed on the display device 27, whereby the operator of the client 2 can perform the retrieval operation. The operation of the WEB page display means 21 involved in the retrieval operation will be described later as a retrieval process (S740).

If the WEB page display means 21 receives a WEB page of a retrieval space selection screen from the retrieval space map means 12, the retrieval space selection screen is displayed on the display device 27, whereby the operator of the client 2 can perform a retrieval space selection operation.

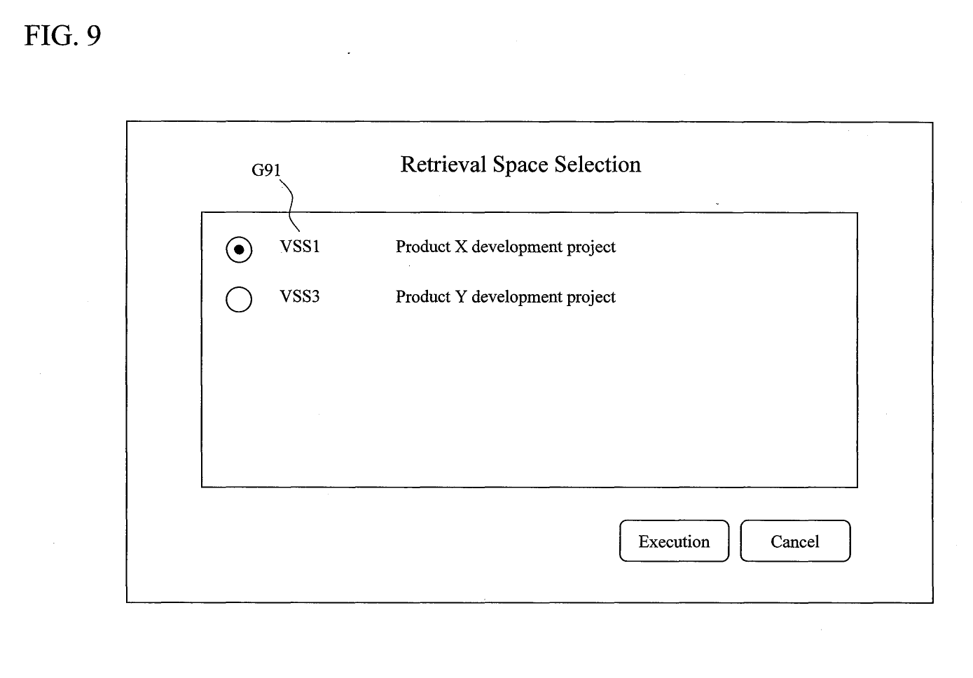

A display example of the retrieval space selection screen is shown in FIG. 9. In a retrieval space selection part (G91) of the retrieval space selection screen, a radio button, a retrieval space ID and a retrieval space name are displayed for every retrieval space which the operator of the client 2 can log in to, as shown in FIG. 9, whereby the operator of the client 2 can select the retrieval space of retrieval object with reference to the displayed retrieval space name. In FIG. 9, a state where “VSS1” is selected is illustrated.

If the operator of the client 2 clicks the radio button for the retrieval space of retrieval object, using the input device 26, to make the radio button active, and clicks an execution button in the lower right part of the retrieval space selection screen, the WEB page display means 21 sends the retrieval space ID corresponding to the active radio button together with the retrieval space selection processing request to the WEB page sending means 11.

On the other hand, if the operator of the client 2 clicks a cancel button in the lower right part of the retrieval space selection screen, the WEB page display means 21 sends a log out processing request to the WEB page sending means 11. The operation of the retrieval space map means 12 involved in the log out operation will be described later as a log out process (S750).

(c) Step S730

The WEB page display means 21 displays the WEB page received from the retrieval space map means 12 on the display device 27.

Accordingly, if the WEB page display means 21 receives the WEB page of the error screen from the retrieval space map means 12, the error screen is displayed on the display device 27, whereby it is necessary that the operator of the client 2 resolves a cause of error and performs the retrieval space selection operation again. In this case, the WEB page display means 21 performs step S720 again.

If the WEB page display means 21 receives a WEB page of a retrieval screen from the retrieval space map means 12, the retrieval screen is displayed on the display device 27, whereby the operator of the client 2 can perform the retrieval operation.

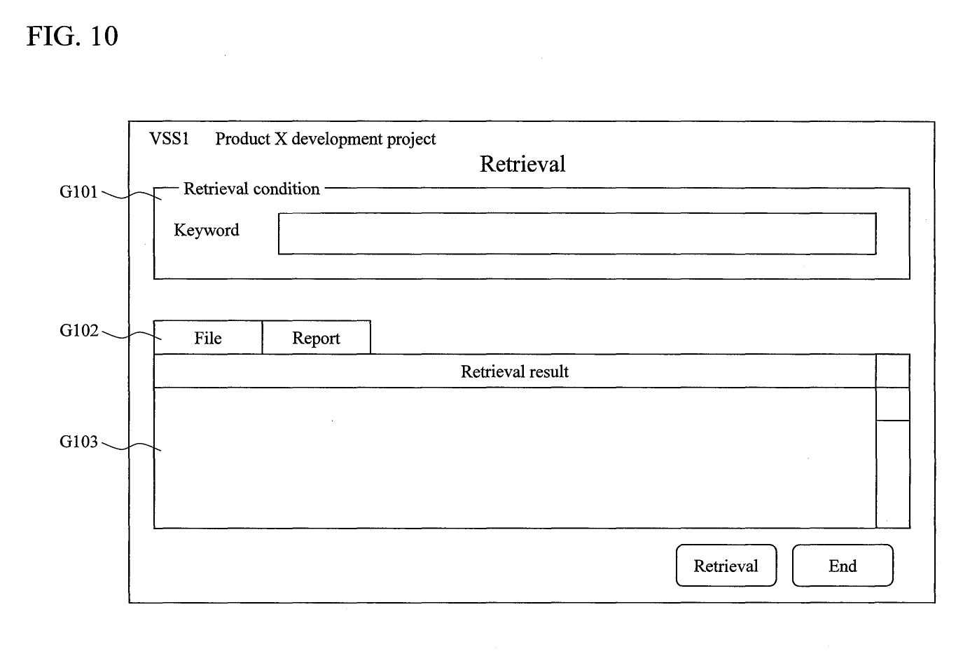

A display example of the retrieval screen is shown in FIG. 10. A retrieval condition designation part (G101), a retrieval result switch button (G102), a retrieval result display part (G103) and the “retrieval” and “end” buttons are displayed on the retrieval screen as shown in FIG. 10. Also, the retrieval space ID (“VSS1”) to which the operator of the client 2 logs in and the retrieval space name (“product X development project”) are displayed in the upper left part of the screen in the example of FIG. 10.

If the operator of the client 2 clicks the end button (YES at S730), the WEB page display means 21 sends a log out processing request to the WEB page sending means 11 (S750). The operation of the retrieval space map means 12 involved in the log out operation will be described later as a log out process.

On the other hand, if the operator of the client 2 inputs a keyword into the retrieval condition designation part (G101) and clicks the execution button (NO at S730), the WEB page display means 21 sends the input keyword together with a retrieval processing request to the WEB page sending means 11 (S740). Though the keyword only is shown as the retrieval condition of the retrieval condition designation part (G101) in FIG. 10, various kinds of data including a designation of the file such as a document file, a table file and an HTML file, the update date of the file and so on can be made the retrieval condition.

(d) Step S740

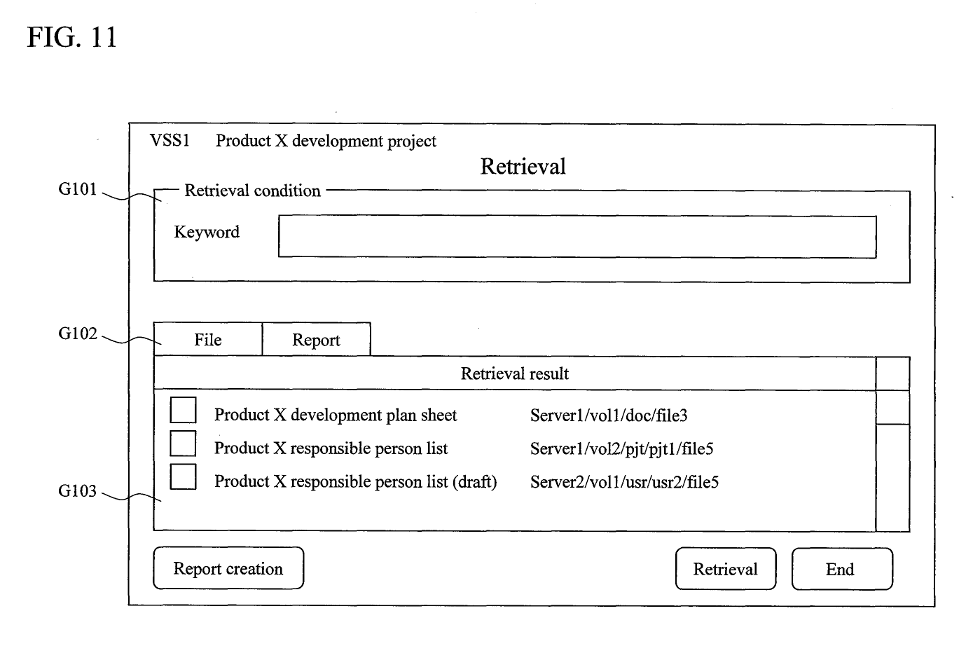

If a retrieval process is ended in the retrieval space map server 1, the WEB page sending means 11 sends a WEB page of a retrieval screen including the retrieval result data to the WEB page display means 21. Then, the WEB page display means 21 displays the received WEB page as the retrieval screen on the display device 27. At this time, a file name (“product X development plan sheet”) and an existence location of the file (“Server1/vol1/doc/file3”) included in the retrieval result data are displayed in the retrieval result display part (G103) of the retrieval screen, as shown in FIG. 11. That is, in FIG. 11, the existence location of file is indicated by the identifier of the file server 4, the logical volume and the file path, corresponding to the explanation for the retrieval space in FIGS. 3 and 4. Though a technique for converting the URL received by the WEB page sending means 11 into another URL or the like is well known. For example, in FIG. 11, if “http://Server1.vsserver.com/vol1/doc/file3” and the URL, not “Server1/vol1/doc/file3” indicating the existence location of file with the identifier of the file server 4, the logical volume and the file path, are displayed and the WEB page display means 21 sends “http://Server1.vsserver.com/vol1/doc/file3” to the WEB page sending means 11, it is also possible to convert into the “Server1/vol1/doc/file3”. In the following explanation, the file existence location and the URL are generically called the URL or the like, as shown in FIG. 11.

d1) Case of Making a File Contents Display Processing Request from the Client 2

If the operator of the client 2 clicks the URL or the like displayed in the retrieval result display part (G103), the WEB page display means 21 sends the clicked URL or the like together with the file contents display processing request to the WEB page sending means 11.

If a display process is ended in the retrieval space map server 1, the WEB page sending means 11 sends a WEB page of a display screen including the contents of the file corresponding to the received URL or the like to the WEB page display means 21. The WEB page display means 21 displays the received WEB page as the display screen on the display device 27.

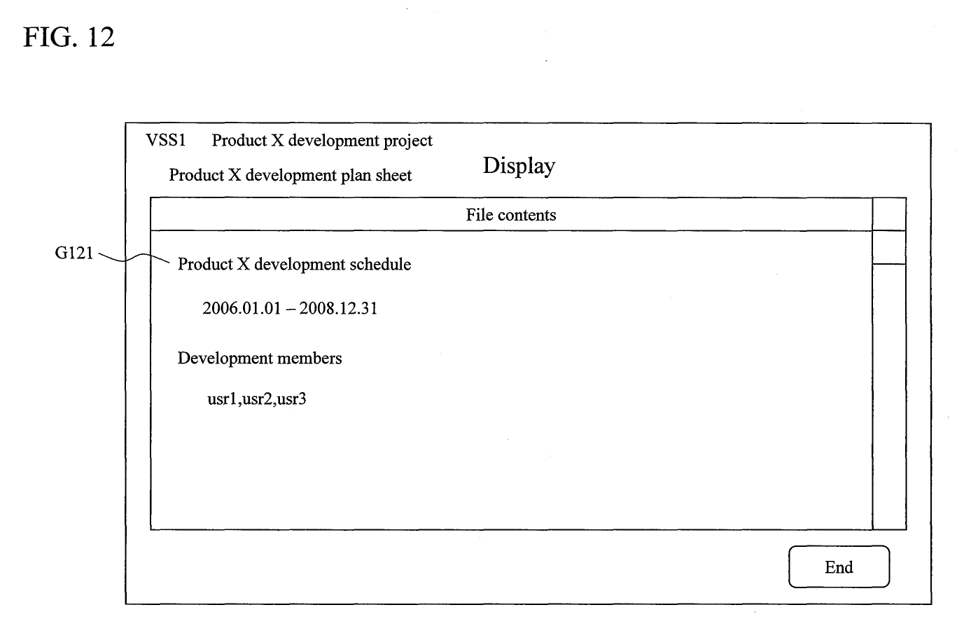

A display example of the display screen is shown in FIG. 12. A file contents display part (G121) and an “end” button are displayed on the display screen, as shown in FIG. 12. Also, the retrieval space ID (“VSS1”) to which the operator of the client 2 logs in, the retrieval space name (“product X development project”), and the file name (“product X development plan sheet”) displaying the file contents are displayed in the upper left part of the screen in the example of FIG. 12.

If the operator of the client 2 clicks the end button of the display screen, the WEB page display means 21 displays the retrieval screen of FIG. 11 again. Accordingly, the operator of the client 2 can confirm the file contents of each file by clicking the URL or the like displayed in the retrieval result display part (G103).

d2) Case of Making a Report Creation Processing Request from the Client 2

The operator of the client 2 can select and store all or part of the files displayed in the retrieval result display part (G103) in the report file 18. It is possible to eliminate the waste of perform the same retrieval many times by storing the retrieval result data in the report file 18. Also, it is possible to share the retrieval result inside the same development project, for example, by selecting and storing only the file matched with the retrieval purpose among the retrieval result data. In this way, the retrieval result with less noise can be obtained from the report file 18, and further large amounts of retrieval space with less noise are so-called grown with the elapse of the time, because the files matched with the retrieval purpose are gradually accumulated by a plurality of operators of the client 2.

More specifically, if the retrieval process is ended, not only the file name included in the retrieval result data but also a check box corresponding to each file name are displayed in the retrieval result display part (G103) of the retrieval screen, as shown in FIG. 11. Also, a “report creation” button is displayed in the lower left part of the screen, as shown in FIG. 11.

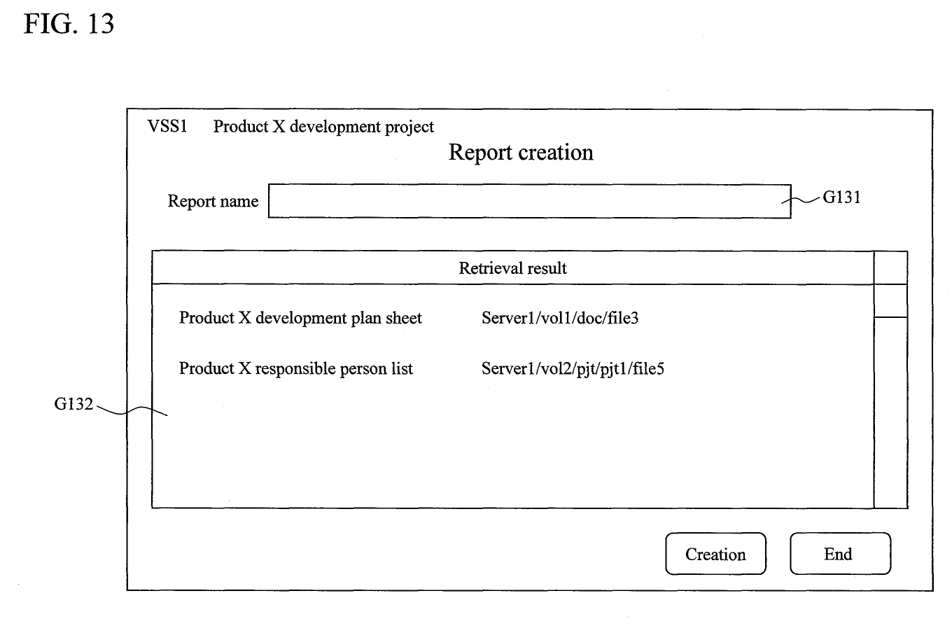

If the operator of the client 2 clicks a check box of the file to be stored in the report file 18, using the input device 26, to make the check box active, and clicks the report creation button, the WEB page display means 21 displays a report creation screen on the display device 27, as shown in FIG. 13.

A report name input field (G131), a selection result display part (G132) and the “creation” and “end” buttons are displayed on the report creation screen, as shown in FIG. 13. The file name and the URL or the like selected by the check box among the file names and the URLs or the like displayed in the retrieval result display part (G103) of the retrieval screen are displayed in the selection result display part (G132). Also, the retrieval space ID (“VSS1”) to which the operator of the client 2 logs in and the retrieval space name (“product X development project”) are displayed in the upper left part of the screen in the example of FIG. 13.

The operator of the client 2 can confirm whether or not the necessary file is selected in the selection result display part (G132) of the report creation screen. And if the operator becomes aware that the unnecessary file is selected, the WEB page display means 21 displays the retrieval screen of FIG. 11 again by clicking the end button on the report creation screen. Accordingly, the operator of the client 2 can retry the file selection by clicking the check box.

On the other hand, if the operator of the client 2 inputs the report name (e.g., “development plan sheet”) appended to the created report in a report name input field (G131), and clicks the creation button, the WEB page display means 21 sends the report name inputted into the report name input field (G131) and the URL or the like displayed in the selection result display part (G132) together with a report creation processing request to the WEB page sending means 11.

If a report creation process is ended in the retrieval space map server 1, the WEB page sending means 11 sends a WEB page of the retrieval screen to the WEB page display means 21. The WEB page display means 21 displays the received WEB page as the retrieval screen on the display device 27, as shown in FIG. 10.

It is possible to not only input the report name, but also change the retrieval result data by editing the file name of the retrieval result data (e.g., changing the “product X development plan sheet” to the “product X development plan sheet (2008.11.10 retrieval version)”) or adding a comment for each retrieval result data such as “a plan proposal different from the present plan” to the retrieval result data. Further, a comment for the entire retrieval result data such as “sharable among all the projects” may be inputted and set in the remarks 18512.

d3) Case of Making a Report Retrieval Result Acquisition Processing Request from the Client 2

If the operator of the client 2 clicks the “report” of the retrieval result switch button (G102) in FIG. 11, the WEB page display means 21 sends a report retrieval result acquisition processing request to the WEB page sending means 11.

If a retrieval result acquisition process is ended in the retrieval space map server 1, the WEB page sending means 11 sends a WEB page of the retrieval screen including the retrieval result data to the WEB page display means 21. The WEB page display means 21 displays the received WEB page as the retrieval screen on the display device 27.

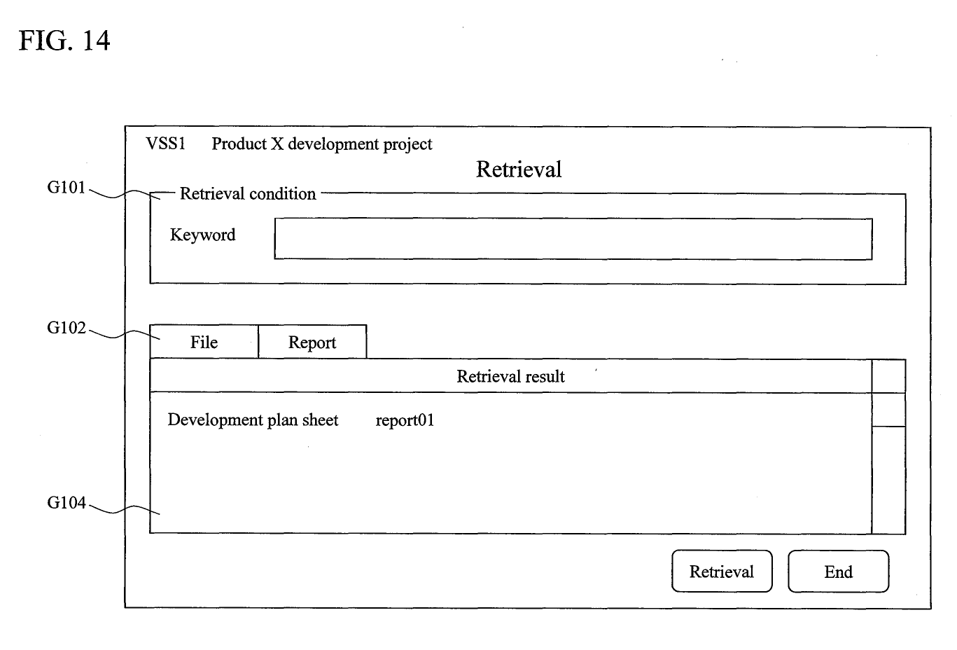

At this time, the report name (“development plan sheet”) and the report ID (“report01”) included in the retrieval result data with the report file 18 as retrieval object are displayed in the retrieval result display part (G103) of the retrieval screen, as shown in FIG. 14 (though only one line of “report01” is displayed in FIG. 14, two or more lines, or no line may be displayed).

In the retrieval process of the retrieval space map means 12, as will be described later, the report file 18 also becomes the retrieval object in addition to the retrieval space selected in the retrieval space selection process, whereby the retrieval of the retrieval space and the retrieval of the report file 18 are performed in parallel. The retrieval space map means 12 stores the retrieval result data for the retrieval space in the retrieval space retrieval result 135 of the retrieval management record 130 for the client 2, and stores the retrieval result data for the report file 18 in the report retrieval result 134. And the retrieval space map means 12 firstly sends a WEB page of the retrieval screen including the retrieval result data for the retrieval space to the WEB page display means 21. Through this process, the retrieval result data for the retrieval space is displayed in the retrieval result display part (G103) of the retrieval screen when the retrieval process is ended, as shown in FIG. 11. And the operator of the client 2 can see the retrieval result data for the report file 18 by clicking the “report” of the retrieval result switch button (G102).

In the case of clicking the “report” of the retrieval result switch button (G102), and further clicking the “file” of the retrieval result switch button (G102), the WEB page display means 21 sends a retrieval space retrieval result acquisition processing request to the WEB page sending means 11. And if a retrieval result acquisition process is ended in the retrieval space map server 1, the WEB page sending means 11 sends a WEB page of the retrieval screen including the retrieval result data for the retrieval space to the WEB page display means 21. The WEB page display means 21 displays the received WEB page as the retrieval screen on the display device 27. Through the above process, the retrieval screen is displayed again on the display device 27, as shown in FIG. 11.

As described above, the retrieval space retrieval result and the report retrieval result are not displayed on the same screen, but displayed separately, whereby the already created report associated with the designated keyword can be found from only the report retrieval result (the noise is small with a relatively small amount). Also, if the file added to the retrieval object file 47 is found after creation of the report, it can be found from within the retrieval space retrieval result only.

That is, though the retrieval of the retrieval space is made mainly with the purpose of retrieving a resource that is a base of creating the report, the retrieval of the report is made with the purpose of retrieving information already scrutinized in connection with the keyword, whereby the retrieval purposes are different. In the case of retrieving two or more dissimilar spaces with such different purposes, the retrieval results are not displayed on the same screen, but preferably displayed separately on different screens.

d4) Case of Making a Report Contents Display Processing Request from the Client 2

If the operator of the client 2 clicks the report ID displayed in the retrieval result display part (G103) in FIG. 14, the WEB page display means 21 sends the clicked report ID together with a report contents display processing request to the WEB page sending means 11.

If a display process is ended in the retrieval space map server 1, the WEB page sending means 11 sends a WEB page of a display screen including the report contents corresponding to the received report ID to the WEB page display means 21. The WEB page display means 21 displays the received WEB page as the display screen on the display device 27.

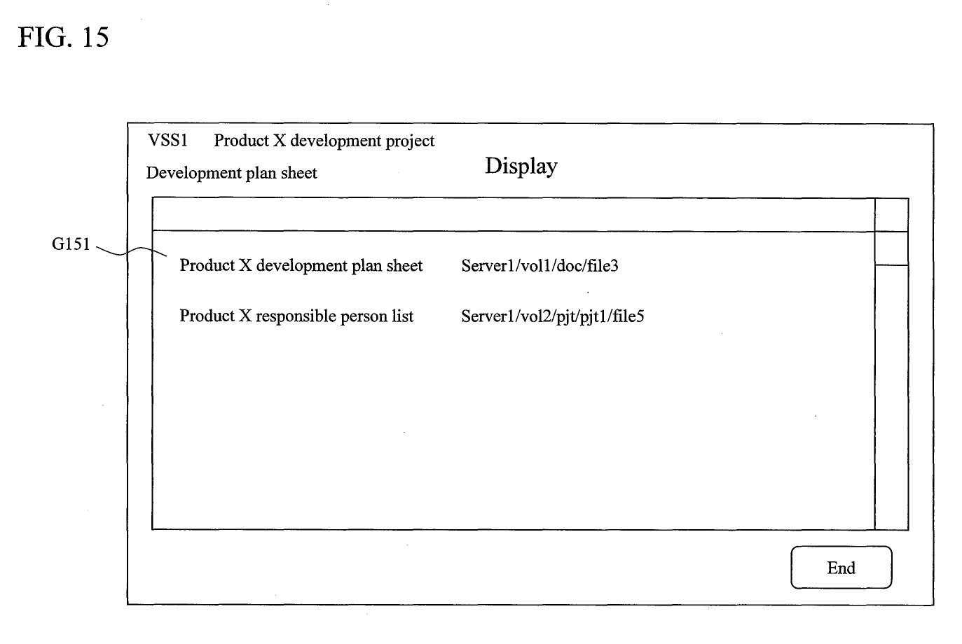

A display example of the display screen is shown in FIG. 15. A report contents display part (G151) and the “end” button are displayed on the display screen, as shown in FIG. 15. Also, the retrieval space ID (“VSS1”) to which the operator of the client 2 logs in, the retrieval space name (“product X development project”) and the report name (“development plan sheet”) indicating the report contents are displayed in the upper left part of the screen in the example of FIG. 15.

If the operator of the client 2 clicks the end button of the display screen, the WEB page display means 21 displays the retrieval screen of FIG. 11 again. Accordingly, the operator of the client 2 can confirm the report contents of each report by clicking the report ID displayed in the retrieval result display part (G103).

The WEB page display means 21 may receive a WEB page of the error screen from the WEB page sending means 11 and display it in each process at S740 as will be described later.

Thus, the explanation for the operation at the client 2 and the process of the WEB page display means 21 is finished. In the following, the operation of the retrieval space map means 12 will be mainly described in the case where the WEB page display means 21 sends the retrieval process request, the file contents display processing request, the report contents display processing request, the report creation processing request, the retrieval space retrieval result acquisition processing request, the report retrieval result acquisition processing request and the log out processing request.

iii) Processing Operation in the Case where the Retrieval Space Map Server 1 Receives a Log in Processing Request from the Client 2

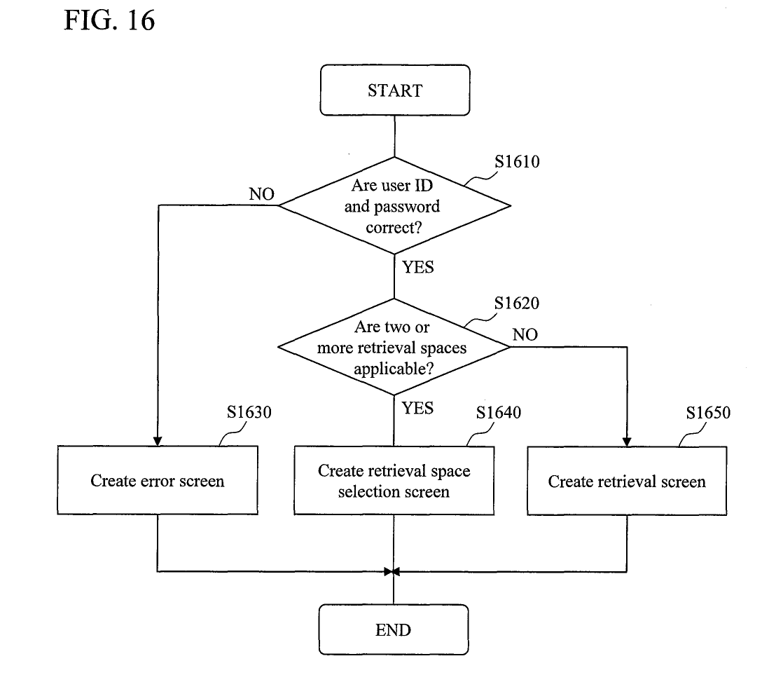

FIG. 16 is a flowchart for explaining the operation of the retrieval space map means 12 in the log in process, namely, in the case where the WEB page sending means 11 receives the log in processing request from the WEB page display means 21.

If the WEB page sending means 11 receives the log in processing request from the WEB page display means 21, the retrieval space map means 12 is started. And the retrieval space map means 12 determines whether or not the combination of a user ID and a password sent by the WEB page sending means 11 is correct, that is, whether or not the combination of user ID and password is matched with the combination of the user ID 174 and the password 175 in any retrieval space definition record 170, or any user log in authority 173 (S1610).

If the combination of the user ID and the password is not matched with the user log in authority 173 in any retrieval space definition record 170 (NO at S1610), the retrieval space map means 12 creates an error screen (S1630), and ends the process. In the following explanation, the phrase “retrieval space map means 12 creates the X screen”, including this error screen, means that the retrieval space map means 12 creates the WEB page composed of the HTML displayed on the display device 27 by the WEB page display means 21.

If the combination of the user ID and the password is matched with any user log in authority 173 in any retrieval space definition record 170 (YES at S1610), the retrieval space map means 12 determines whether or not there are two or more applicable retrieval spaces, that is, the combination of the user ID and the password is matched with any user log in authority 173 in a plurality of retrieval space definition records 170 (S1620). If there are two or more applicable retrieval spaces (YES at S1620), the retrieval space selections screen is created (S1640), or if there is only one applicable retrieval space (NO at S1620), the retrieval screen is created (S1650).

In creating the retrieval space selection screen (S1640), the retrieval space map means 12 sets, as a part of the WEB page, the retrieval space ID 171 and the retrieval space name 172 of the record in which any user log in authority 173 is matched with the combination of the user ID and the password received from the WEB page display means 21 among the retrieval space definition records 170. Thereby, all the retrieval spaces to which the operator of the client 2 can log in are displayed on the display device 27 of the client 2, as indicated at G91 in FIG. 9, whereby the operator of the client 2 can select the retrieval space ID 171 suitable for the purpose by referring to the displayed retrieval space name 172.

Also, in creating the retrieval space selection screen (S1640), the retrieval space map means 12 creates the retrieval management record 130 for the client 2 of the WEB page display means 21 that sends the log in processing request. More specifically, the client identification 131 is set to data (IP address of the client 2) capable of identifying the client 2 that sends the log in processing request, the user ID 133 is set to the user ID received from the WEB page display means 21, and the retrieval space ID 132, the report retrieval result 134 and the retrieval space retrieval result 135 are set to the null value (space), or data indicating that the set value is not yet decided (in the following explanation, it is presupposed that the client identification 131 is set to the IP address of the client 2, and the retrieval space ID 132, the report retrieval result 134 and the retrieval space retrieval result 135 are set to space). Accordingly, in the following process, the retrieval space map means 12 can know the operator of the processing object client 2 by referring to the user ID 133, and can know that the retrieval space for the client 2 and the user ID 133 is not decided because space is set to the retrieval space ID 132.

In creating the retrieval space (S1650), the retrieval space map means 12 sets, to the WEB page, the retrieval space ID 171 and the retrieval space name 172 in the record in which any user log in authority 173 is matched with the combination of the user ID and the password received from the client 2 among the retrieval space definition records 170. Thereby, the retrieval space ID to which the operator of the client 2 logs in and the retrieval space name are displayed on the display device 27 of the client 2, as shown in the upper left part of FIG. 10, so that the operator of the client 2 can confirm the retrieval space ID 171 to which the operator logs in to be suitable for retrieval.

Also, in creating the retrieval screen (S1650), the retrieval space map means 12 creates the retrieval management record 130 for the client 2 of the WEB page display means 21 that sends the log in processing request. More specifically, the client identification 131 is set to data (IP address of the client 2) capable of identifying the client 2 that sends the log in processing request, the retrieval space ID 132 is set to the retrieval space ID 171 in the record in which any user log in authority 173 is matched with the combination of the user ID and the password received from the client 2, the user ID 133 is set to the user ID received from the WEB page display means 21, and the report retrieval result 134 and the retrieval space retrieval result 135 are set to the null value (space), or data indicating that the set value is not yet decided (in the following explanation, it is presupposed that the client identification 131 is set to the IP address of the client 2, and the report retrieval result 134 and the retrieval space retrieval result 135 are set to space). Accordingly, in the following process, the retrieval space map means 12 can know the operator of the client 2 of processing object by referring to the user ID 133, and can know the retrieval space for the client 2 of processing object and the user ID 133 by referring to the retrieval space ID 132.

The retrieval space map means 12 ends the process after creating the retrieval space selection screen or retrieval screen. And the error screen, the retrieval space selection screen or the retrieval screen created by the retrieval space map means 12, namely, the WEB page of each screen, is sent to the WEB page display means 21 by the WEB page sending means 11.

iv) Processing Operation in the Case where the Retrieval Space Map Server 1 Receives a Retrieval Space Selection Processing Request from the Client 2

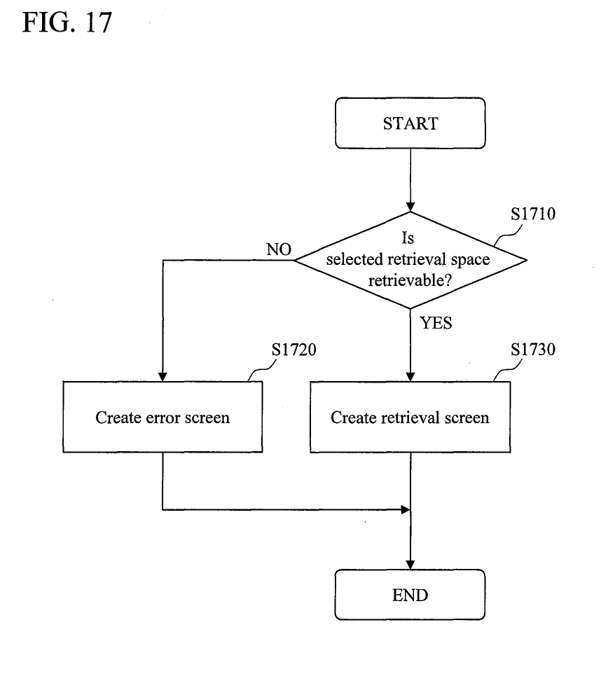

FIG. 17 is a flowchart for explaining the operation of the retrieval space map means 12 in the retrieval space selection process, namely, in the case where the WEB page sending means 11 receives the retrieval space selection processing request from the WEB page display means 21.

If the WEB page sending means 11 receives the retrieval space selection processing request from the WEB page display means 21, the retrieval space map means 12 is started. And the retrieval space map means 12 determines whether or not the operator of the client 2 can retrieve the selected retrieval space (S1710). More specifically, reference is made to the user ID 133 of the retrieval management record 130 in which the client identification 131 is matched with the IP address of the client 2 for the WEB page display means 21 that sends the retrieval space selection processing request. And it is determined whether or not the user ID 174 of the retrieval space definition record 170 in which the retrieval space ID 1710 is matched with the retrieval space ID sent by the WEB page sending means 11 is matched with the user ID 133, in which if so, it is determined that the selected retrieval space is retrievable, or otherwise, it is determined that the selected retrieval space is not retrievable.

Since the above description that the “the user ID 133 of the retrieval management record 130 matched with the IP address of the client 2 for the WEB page display means 21 that sends the processing request” is accurate but redundant and rather difficult to understand, they are simply termed as the “object retrieval management record 130” and the “object user ID 133” in the following explanation. Similarly, in the description of the “user ID 174 of the retrieval space definition record 170 in which the retrieval space ID 171 is matched with the retrieval space ID sent by the WEB page sending means 11”, they are simply termed as the “object retrieval space definition record 170” and the “object user ID 174”.

If it is determined that the selected retrieval space is not retrievable (NO at S1710), the retrieval space map means 12 creates the error screen (S1720) and ends the process.

On the other hand, if it is determined that the selected retrieval space is retrievable (YES at S1710), the retrieval space map means 12 creates the retrieval screen (S1730) and ends the process.

In creating the retrieval screen (S1730), the retrieval space map means 12 sets the object retrieval space ID 171 and the object retrieval space name 172 to the WEB page. Thereby, the retrieval space ID and the retrieval space name to which the operator of the client 2 can log in are displayed on the display device 27 of the client 2, as shown in the upper left part of the screen in FIG. 10, so that the operator of the client 2 can confirm the retrieval space ID 171 to which the operator logs in to be suitable for retrieval.

Also, in creating the retrieval screen (S1730), the retrieval space map means 12 sets the retrieval space ID received from the client 2 to the retrieval space ID 132 of the object retrieval management record 130. Accordingly, in the following process, the retrieval space map means 12 can know the operator of the client 2 of processing object by referring to the user ID 133 and can know the retrieval space for the client 2 of processing object and the user ID 133 by referring to the retrieval space ID 132.

The retrieval space map means 12 creates the retrieval space selection screen or retrieval space and ends the process. And the error screen or the retrieval screen created by the retrieval space map means 12, namely, the WEB page of each screen, is sent to the WEB page display means 21 by the WEB page sending means 11.

v) Processing Operation in the Case where the Retrieval Space Map Server 1 Receives a Retrieval Processing Request from the Client 2

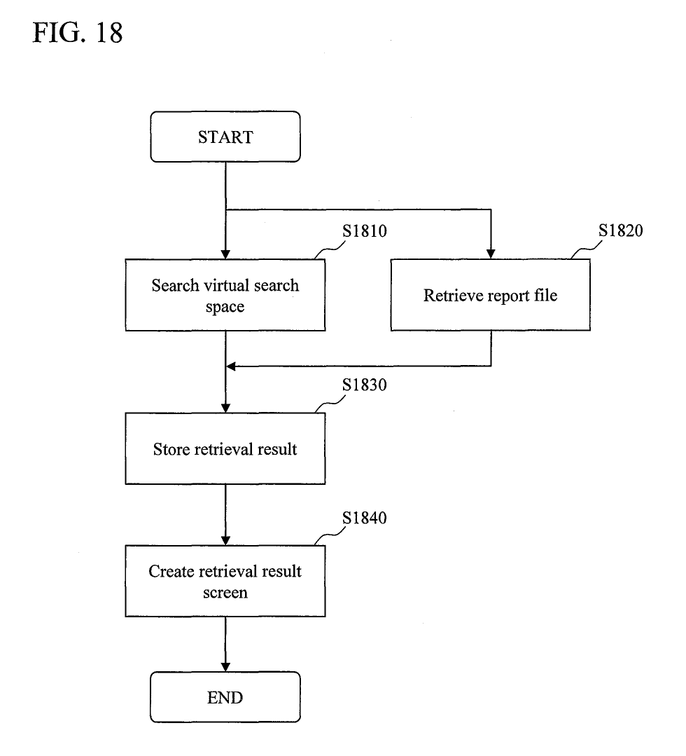

FIG. 18 is a flowchart for explaining the operation of the retrieval space map means 12 in the retrieval process.

If the WEB page sending means 11 receives the retrieval processing request from the WEB page display means 21, the retrieval space map means 12 is started. Then, the retrieval space map means 12 performs the retrieval (S1810) of the virtual search space and the retrieval (S1820) of the report file 18 in parallel. The term “parallel” as used herein means performing the retrieval of the report file 18 (S1820) and the retrieval of the virtual search space (S1810) independently by creating a thread corresponding to each of the retrieval of the report file 18 (S1820) and the retrieval of the virtual search space (S1810), for example, rather than firstly performing the retrieval of the report file 18 (S1820) and then performing the retrieval of the virtual search space (S1810), for example.

Since the actual retrieval result at the present time (result of performing the retrieval by the keyword that the operator (user) inputs) is firstly displayed as the retrieval result, as shown in FIG. 11, the retrieval of the applicable virtual search space may be firstly performed, and when the operator clicks the retrieval result switch button (G102) of “report”, the retrieval of the report file may be performed. Since the retrieval of the report file is performed for the report file 18 stored in the storage device 16 for the retrieval space map server 1 itself, the transmission or reception is not made via the LAN 9, so that a load on the system is extremely smaller than in the actual retrieval space, whereby there hardly occurs a problem with the response time in this way.

The retrieval process (S1810) of the virtual search space is performed in the following way. That is, the retrieval space map means 12 acquires the retrieval space ID 132 (object retrieval space ID 132) from the retrieval management record 130 (object retrieval management record 130) for the client 2 of the WEB page display means 21 that sends the retrieval processing request. And the retrieval space map means 12 creates a retrieval command from the retrieval object 176 of the retrieval space definition record 170 in which the retrieval space ID 171 is matched with the object retrieval space ID 132 and the retrieval keyword received from the WEB page display means 21 and sends it to the retrieval means 31.

Also, the retrieval process (S1820) of the report file 18 is performed in the following way. That is, the retrieval space map means 12 determines whether or not the retrieval keyword received from the WEB page display means 21 is included in the retrieval result 184 of the report record 180 in which the retrieval space ID 183 is matched with the object retrieval space ID 132, and acquires the report ID 181 and the report name 182 of the report record 180 in which the retrieval keyword is included in the retrieval result 184.

The retrieval space map means 12 receives the retrieval result data from the retrieval means 31, and sets the retrieval result data to the retrieval space retrieval result 135 of the object retrieval management record 130. Also, the report ID 181 and the report name 182 acquired from the report record 180 at step S1820 are set to the report retrieval result 134 (step S1830).

Next, the retrieval space map means 12 creates the retrieval result screen (S1840), and ends the process. Herein, in creating the retrieval result screen (S1840), the retrieval space map means 12 sets the file name and the URL or the like included in the retrieval result data received from the retrieval means 31 to the WEB page.

For the retrieval (S1810) of the virtual search space, the retrieval space map means 12 sends the retrieval command to the retrieval means 31, and waits for the retrieval result data to be sent from the retrieval means 31 for a predetermined time (e.g., one second), in which if the predetermined time is exceeded, it is determined that the retrieval fails due to an abnormality in the communication line. Also, if it is determined that the retrieval fails, the retrieval may be performed again a predetermined number of times (e.g., three times).

Further, if the retrieval (S1820) of the report file 18 is successful even though it is determined that the retrieval (S1810) of the virtual search space finally fails because the retrieval fails the predetermined number of times, the report retrieval result 134 is set up, and the WEB page in which the file name and the URL or the like are not set may be created as the retrieval result screen of the virtual search space. In this way, the operator of the client 2 can see the retrieval result data only for the report file 18 by clicking the “report” of the retrieval result switch button (G102) on the retrieval screen.

Conversely, if the retrieval (S1820) of the report file 18 fails due to a failure of the storage device 16, but the retrieval (S1810) of the virtual search space is successful, the retrieval space retrieval result 135 is set up, and the retrieval screen may be created by setting the file name and the URL or the like included in the retrieval result data received from the retrieval means 31 to the WEB page. In this way, the operator of the client 2 can see the retrieval result data only for the retrieval space.

On the other hand, if any of the retrieval (S1810) of the virtual search space and the retrieval (S1820) of the report file 18 fails, the retrieval space map means 12 may create the error screen and end the process. In this way, the operator of the client 2 can judge that the entire retrieval process is normally performed if the retrieval screen is displayed.

The error screen or the retrieval screen created by the retrieval space map means 12, namely, the WEB page of each screen, is sent to the WEB page display means 21 by the WEB page sending means 11, whereby the retrieval screen is displayed on the display device 27, as shown in FIG. 11.

Since the retrieval of the virtual search space and the retrieval of the report file 18 are performed in parallel in the above way, the processing time from the start of retrieval to the end of both retrievals can be shortened as compared with the case where the retrieval of the virtual search space and the retrieval of the report file 18 are performed serially. Indeed, the retrieval of the report file 18 can be performed without requiring the transmission or reception of a large amount of data involving transmitting the retrieval command to the retrieval means 31 and receiving the retrieval result data from the retrieval means 31, and is completed generally in a shorter time than the retrieval of the virtual search space. That is, the processing time taken for the retrieval of the report file 18 is typically negligible to the processing time taken for the retrieval of the virtual search space. Accordingly, the retrieval of the virtual space and the retrieval of the report file 18 may be performed serially by firstly performing the retrieval of the virtual space and performing the retrieval of the report file 18 after the retrieval of the virtual space is normally ended. In this way, if the retrieval of the virtual space is not normally ended due to a communication error, the retrieval of the report file 18 may not be performed, whereby the wasteful retrieval process is dispensed with.

Of importance here is that the retrieval of the virtual search space and the retrieval of the report file 18 are not performed at the different retrieval request timings in which the retrieval of the virtual search space only is performed if the retrieval request of the virtual search space is received, and the retrieval of the report file 18 only is performed if the retrieval request of the report file 18 is received, but if the retrieval processing request of the virtual search space is received from the WEB page display means 21, the retrieval of the virtual search space and the retrieval of the report file 18 are performed in parallel at the same time, or serially and consecutively, to perform the retrieval processes (at the same retrieval request timing). In this way, it is possible to display the retrieval result of the report file 18 consistent with the retrieval result of the virtual search space.

vi) Processing Operation in the Case where the Retrieval Space Map Server 1 Receives a Retrieval Space Retrieval Result Acquisition Processing Request or Report Retrieval Result Acquisition Processing Request from the Client 2

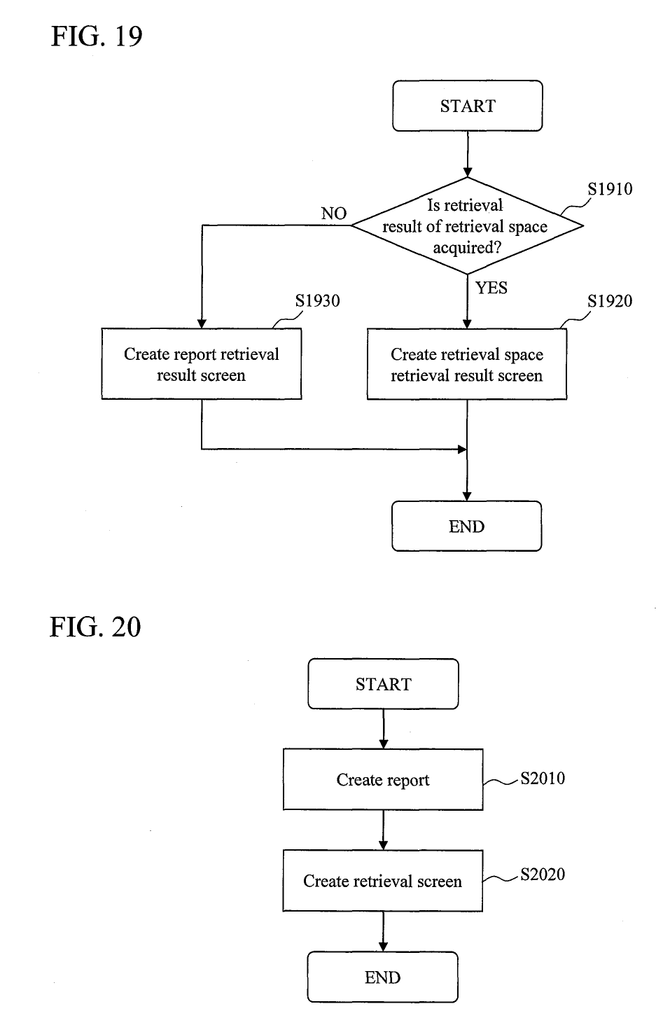

FIG. 19 is a flowchart for explaining the operation of the retrieval space map means 12 in the retrieval result acquisition process.

If the WEB page sending means 11 receives a retrieval processing request from the WEB page display means 21, the retrieval space map means 12 is started. Then, the retrieval space map means 12 determines whether or not the processing request sent from the WEB page display means 21 is the retrieval space retrieval result acquisition processing request (S1910). If the processing request is the retrieval space retrieval result acquisition processing request (YES at S1910), the retrieval space map means 12 creates the retrieval result screen for the retrieval space (S1920), or if the processing request is not the retrieval space retrieval result acquisition processing request, namely, the report retrieval result acquisition processing request (NO at S1910), the retrieval space map means 12 creates the retrieval result screen for the report file 18 (S1930).

The retrieval space map means 12 creates the retrieval result screen for the retrieval space or the retrieval result screen for the report file 18 and ends the process.

In creating the retrieval result screen for the retrieval space (S1920), the retrieval space map means 12 acquires the retrieval space retrieval result 135 (object retrieval space retrieval result 135) from the retrieval management record 130 for the client 2 of the WEB page display means 21 that sends the retrieval space retrieval result acquisition processing request, and sets the file name and the URL or the like included in the object retrieval space retrieval result 135 to the WEB page.

In creating the retrieval result screen for the report file 18 (S1930), the retrieval space map means 12 acquires the report retrieval result 134 (object report retrieval result 134) from the retrieval management record 130 for the client 2 of the WEB page display means 21 that sends the retrieval space retrieval result acquisition processing request, and sets the file name and the report ID included in the object report retrieval result 134 to the WEB page.

The retrieval (result) screen created by the retrieval space map means 12, namely, the WEB page of the retrieval (result) screen is sent to the WEB page display means 21 by the WEB page sending means 11. As a result, if the WEB page display means 21 sends the retrieval space retrieval result acquisition processing request, the retrieval screen is displayed on the display device 27 as shown in FIG. 11, or if the WEB page display means 21 sends the report retrieval result acquisition processing request, the retrieval screen is displayed on the display device 27 as shown in FIG. 14.

As above described using FIG. 18, if the WEB page sending means 11 receives the retrieval processing request from the WEB page display means 21, it performs the retrieval for both the virtual search space and the report file 18 at the same time and stores the respective retrieval results in the retrieval space retrieval result 135 and the report retrieval result 134.

And if the operator of the client 2 clicks the “file” of the retrieval result switch button (G102), the retrieval result stored in the retrieval space retrieval result 135 is displayed without performing the retrieval of the virtual search space again, while if the operator of the client 2 clicks the “report”, the retrieval result stored in the report retrieval result 134 is displayed without performing the retrieval of the report file 18 again.

That is, only in the case where the retrieval condition (G101) is newly designated and the case where the retrieval condition (G101) is changed, the retrieval of the virtual search space and the retrieval of the report file 18 are performed at the same time, and both the retrieval results are stored, whereby the fixed retrieval result can be always displayed if the retrieval result switch button (G102) is operated without changing the retrieval condition (G101).

Accordingly, in the case where after the operator of the client 2 newly designates the retrieval condition (G101) and performs the retrieval, the operator of another client 2 adds the file to the retrieval object file 47, for example, the display contents of the retrieval result screen for the retrieval space are unchanged. Accordingly, the operator of the client 2 can confirm the retrieval results, comparing both the retrieval results with the eyes, by switching the display screen with the retrieval result switch button (G102), while scrolling the retrieval result screen for the retrieval space and the retrieval result screen for the report file 18, for example. In this case, if the scroll display position on each retrieval result screen is set to the retrieval management record 130, it is possible to display in a scrolled state before switch, in the case where after the retrieval result screen for the retrieval space is scrolled, the retrieval result screen for the report file 18 is displayed, and the retrieval result screen for the retrieval space is displayed again, for example.

vii) Processing Operation in the Case where the Retrieval Space Map Server 1 Receives a Report Creation Processing Request from the Client 2

FIG. 20 is a flowchart for explaining the operation of the retrieval space map means 12 in the report creation process.

If the WEB page sending means 11 receives the report creation processing request from the WEB page display means 21, the retrieval space map means 12 is started. Then, the retrieval space map means 12 creates the report record 180 (S2010). More specifically, the retrieval space map means 12 sets an ID such as “report01” capable of uniquely identifying the report record 180 to the report ID 181, and sets the report name received from the WEB page display means 21 to the report name 182.

Also, the retrieval space map means 12 acquires the retrieval space ID 132 from the retrieval management record 130 (object retrieval management record 130) for the client 2 of the WEB page display means 21 that sends the report creation processing request, and sets it to the retrieval space ID 183.

Further, the retrieval space map means 12 acquires the retrieval space retrieval result 135 (object retrieval space retrieval result 135) from the object retrieval management record 130, and acquires the file name corresponding to the URL or the like received from the WEB page display means 21 from the file name and the URL or the like included in the object retrieval space retrieval result 135. And the URL or the like received from the WEB page display means 21 and the acquired file name are set to the retrieval result 184 by the number of URLs received from the WEB page display means 21. If the number of URLs received from the WEB page display means 21 is zero, that is, if the report creation button is clicked without making the check box of the retrieval result display part (G103) active on the retrieval screen of FIG. 11, and the creation button is clicked on the report creation screen of FIG. 13, for example, any of the file name and URL or the like are not set to the retrieval result 184. That is, in this case, the repetition number n of the retrieval result 184 is zero.

The retrieval space map means 12 stores the report record 180 with the above data set in the report file 18.

Next, the retrieval space map means 12 creates the retrieval screen (S2020) and ends the process. The creation processing contents of the retrieval screen are the same as the retrieval screen creation (S1730) of the retrieval space selection process (FIG. 17) as previously described.

The retrieval screen created by the retrieval space map means 12, namely, the WEB page of the retrieval screen, is sent to the WEB page display means 21 by the WEB page sending means 11. As a result, the retrieval screen is displayed on the display device 27, as shown in FIG. 10.

viii) Processing Operation in the Case where the Retrieval Space Map Server 1 Receives a File Contents Display Processing Request or Report Contents Display Processing Request from the Client 2

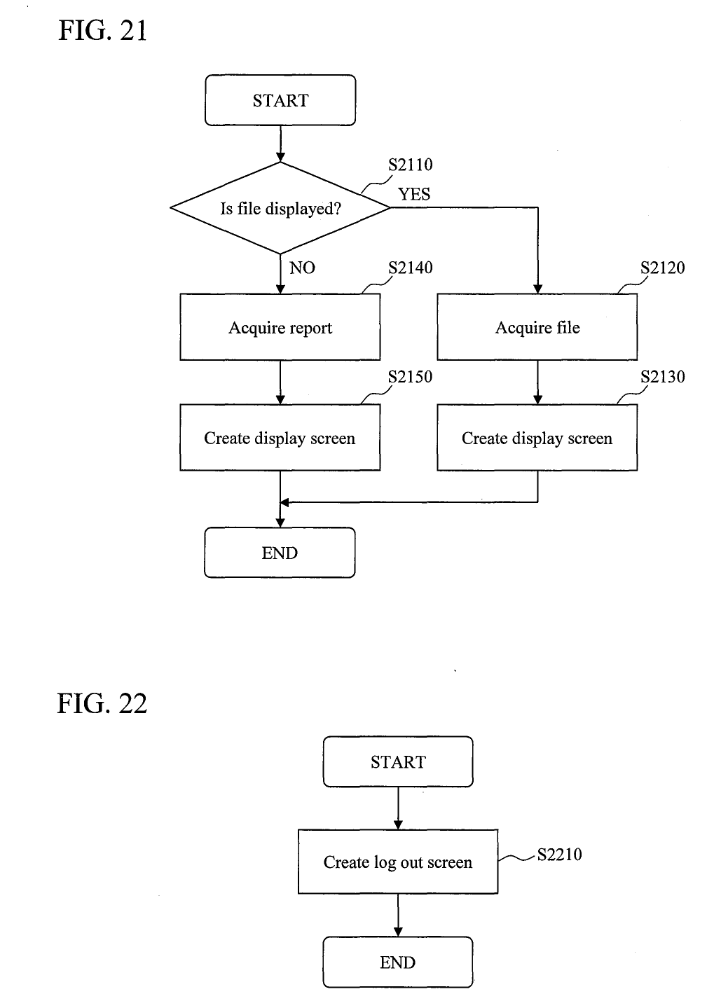

FIG. 21 is a flowchart for explaining the operation of the retrieval space map means 12 in the display process.

If the WEB page sending means 11 receives the file contents display processing request or report contents display processing request from the WEB page display means 21, the retrieval space map means 12 is started. Then, the retrieval space map means 12 determines whether or not the processing request sent from the WEB page display means 21 is the file contents display processing request (S2110).

If the processing request is the file contents display processing request (YES at S2110), the retrieval space map means 12 acquires the file indicated by the URL or the like received from the WEB page display means 21 (S2120). More specifically, if the URL or the like is “Server 1/vol1/doc/file3”, for example, a “/doc/file3” file in the logical volume having a logical volume name of “vol1” for the file server 4 having an identifier of “Server1” is acquired via the LAN 9. And the contents of the file are edited into the WEB page to create the display screen (S2130), and the process is ended.

The steps S2120 and S2130 is not performed by the retrieval space map means 12, but may be performed by the WEB page sending means 11. In this case, the WEB page sending means 11 determines whether or not the URL or the like received from the WEB page display means 21 satisfies a predetermined condition (e.g., “reportX” (X is the numerical value of one or more digits)) before starting the retrieval space map means 12, in which if the predetermined condition is satisfied, the retrieval space map means 12 is started, or if the predetermined condition is not satisfied, the WEB page indicated by the URL or the like received from the WEB page display means 21 is acquired and sent to the WEB page display means 21 with the normal WEB server function.

On the other hand, if the processing request is not the file contents display processing request, that is, if the processing request is the report contents display processing request (NO at S2110), the retrieval space map means 12 acquires the report record 180 in which the report ID 181 is matched with the report ID received from the WEB page display means 21 (S2140), edits data set in the retrieval result 184 of the report record 180, namely, the file name and URL or the like, into the WEB page to create the display screen (S2150), and ends the process. If the repetition number n of the retrieval result 184 is zero, that is, any of the file name and the URL or the like are not set to the retrieval result 184, the display screen in which the file name and the URL or the like are not set is created.

The display screen created by the retrieval space map means 12, namely, the WEB page of the display screen, is sent to the WEB page display means 21 by the WEB page sending means 11. As a result, if the WEB page display means 21 sends the file contents display processing request, the display screen is displayed on the display device 27, as shown in FIG. 12, while if the WEB page display means 21 sends the report contents display processing request, the display screen is displayed on the display device 27, as shown in FIG. 15.

In the above process, if every retrieval result 184 set in the report record 180 is edited into the WEB page, the operator of the client 2 can know the URL or the like of every retrieved file, and can also know the existence of the file retrieved by the different operator. This is favorable from the viewpoint of sharing information in the overall development project, for example, but on the other hand, leads to a situation that the existence location of the file without access authority is known. Accordingly, if the security is more important, it is determined at step S1540 whether or not the operator of the client 2 has the access authority to the URL or the like for each retrieval result 184, and if there is no access authority, the file name and the URL or the like for the retrieval result 184 are not set to the WEB page.

Also, in this case, the file name may be set and the URL or the like may not be set. In this way, since it can be indicated that the file pertinent to the retrieval purposes exists while the existence location of the file is kept secret, the operator of the client 2 can obtain information from the person having the access authority to the file.

ix) Processing Operation in the Case where the Retrieval Space Map Server 1 Receives a Log Out Processing Request from the Client 2

FIG. 22 is a flowchart for explaining the operation of the retrieval space map means 12 in the log out process.

If the WEB page sending means 11 receives the log out processing request from the WEB page display means 21, the retrieval space map means 12 is started. Then, the retrieval space map means 12 deletes the retrieval management record 130 for the client 2 of the WEB page display means 21 that sends the log in processing request, creates a log out screen (S2210), and ends the process.

The log out screen created by the retrieval space map means 12, namely, the WEB page of the log out screen, is sent to the WEB page display means 21 by the WEB page sending means 11, and displayed on the display device 27.

### (2) Second Embodiment

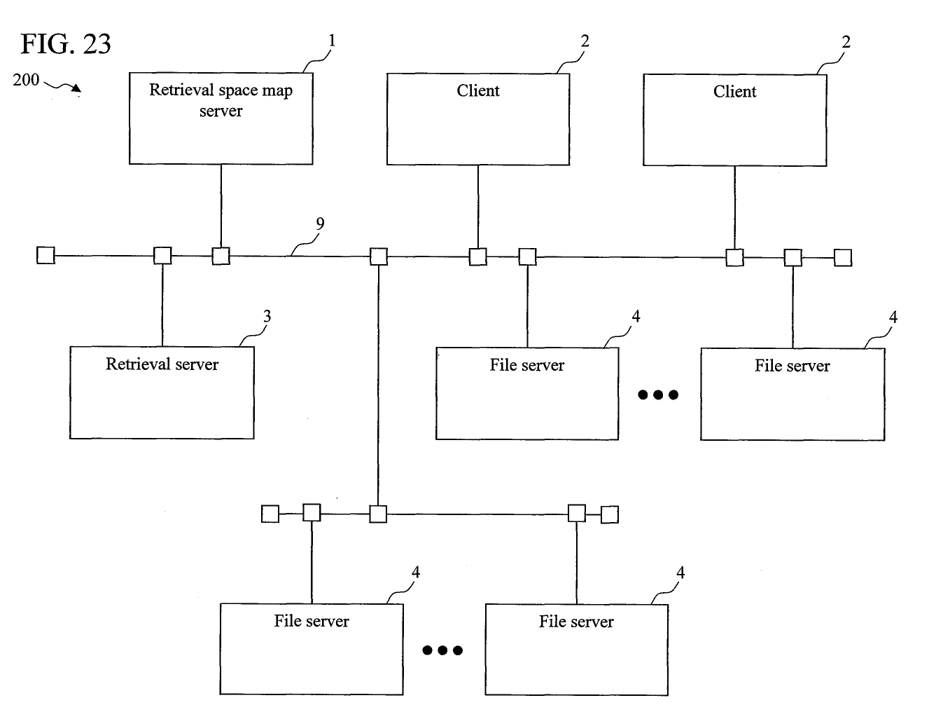

FIG. 23 is a diagram showing the schematic configuration of a retrieval space mapping system (retrieval system) 200 according to a second embodiment of the invention.

The retrieval space mapping system 200 comprises a retrieval space map server 1, a retrieval server 3, a file server 4, and a client 2 (hereinafter referred to as the “server or the like”), in which they are connected to be communicable with each other via the wire or wireless communication line such as a LAN 9. The configuration of each server or the like according to the second embodiment, which is the same as the first embodiment, is omitted in FIG. 23. Also, the function and operation of each server or the like are the same as the first embodiment.

The second embodiment is different from the first embodiment in that a part of the file server 4 exists on a LAN segment different from the retrieval space map server 1.

In this way, the retrieval space map server 1, the retrieval server 3, the file server 4 and the client 2 can be connected by the communication line of various configurations.

### (3) Third Embodiment

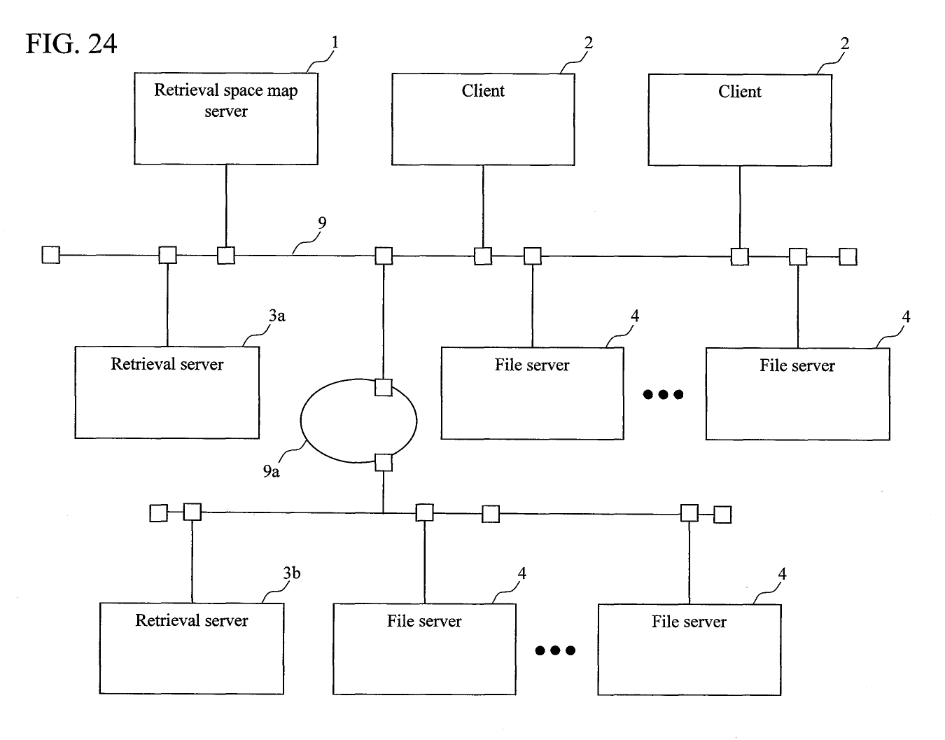

FIG. 24 is a system block diagram of a retrieval space mapping system (retrieval system) 300 according to a third embodiment of the invention.

The retrieval space mapping system 300 comprises a retrieval space map server 1, the retrieval servers 3 (3a and 3b), a file server 4, and a client 2 (hereinafter referred to as the “server or the like”), in which they are connected to be communicable with each other via the wire or wireless communication line such as a LAN 9 or an internet 9a. The configuration of each server or the like in the third embodiment, which is the same as the first embodiment, is omitted in FIG. 24. Also, the function and operation of each server or the like are the same as the first embodiment, except for the points as will be described later.

The third embodiment is different from the first embodiment in that a part of the retrieval server 3 and the file server 4 exists on a LAN segment different from the retrieval space map server 1 and the LAN segments are connected to be communicable with each other via the internet 9a.

Also, in the third embodiment, a process where the retrieval space map means 12 searches the virtual search space (S1810 in FIG. 18) is different from the first embodiment. That is, in the third embodiment, the retrieval space ID 132 (object retrieval space ID 132) is acquired from the retrieval management record 130 (object retrieval management record 130) for the client 2 of the WEB page display means 21 that sends the retrieval processing request, and a retrieval command is created from the retrieval object 176 of the retrieval space definition record 170 in which the retrieval space ID 171 is matched with the object retrieval space ID 132 and the retrieval keyword received from the WEB page display means 21 as in the first embodiment, but after that, the retrieval command is sent to a plurality of retrieval means 31 in the third embodiment.

At this time, if each retrieval means 31 (retrieval program) is the same program and can understand the same retrieval command, the retrieval command sent to each retrieval means 31 may be the same. In this way, the function of the retrieval space map means 12 can be made plainer.

On the other hand, if each retrieval means 31 (retrieval program) is the different program and cannot understand the same retrieval command, it is required to send the different retrieval command to each retrieval means 31. In this case, a retrieval command creation rule for each retrieval means 31 is stored in a storage device 16 of the retrieval space map server 1, not shown in FIG. 24, and the retrieval space map means 12 may create the retrieval command by referring to this retrieval command creation rule. For example, in the case where “(Keyword=‘projectX’ and (Filetype=‘doc’ or ‘txt’)” is set to the retrieval object 176, and the retrieval means 31a of the retrieval server 3a comprises the retrieval function with retrieval keyword and file extension, while the retrieval means 31b of the retrieval server 3b comprises the retrieval function with retrieval keyword but does not have the retrieval function with file extension, the retrieval command for the retrieval means 31a is “SearchFile (Keyword=‘projectX’ and (Filetype=‘doc’ or ‘txt’))” (retrieving the file including the keyword of ‘projectX’ and with the file extension of ‘doc’ or ‘txt’), while the retrieval command for the retrieval means 31b is “SearchFile (Keyword=‘projectX’)” (retrieving the file including the keyword of ‘projectX’). And the file with file extension ‘doc’ or ‘txt’ may be selected from the retrieval result data received from the retrieval means 31b.

The retrieval of each retrieval means 31 may be performed in parallel. The term “parallel” as used herein means performing the retrieval by each retrieval means 31 independently by creating a thread corresponding to each of the plurality of retrieval means 31 to send the retrieval command to each retrieval means 31 and receive the retrieval result data from each retrieval means 31, for example, rather than sending the retrieval command to one retrieval means 31, waiting until the retrieval result data is received from the retrieval means 31, and sending the retrieval command to another retrieval means 31 after receiving.

Further, if the retrieval of the retrieval means 31 fails due to an abnormality in the communication line, but the retrieval of other retrieval means 31 is successful, the retrieval (S1810) of the virtual search space is successful as a whole, whereby the setting (S1830) of the retrieval space retrieval result 135 may be made. In this way, the operator of the client 2 can see the retrieval result data for the retrieval space, unless the retrieval of every retrieval means 31 fails.

On the other hand, if any retrieval of the retrieval means 31 fails, the retrieval space map means 12 may create the error screen and end the process. In this way, the operator of the client 2 can judge that all the retrieval process is normally performed when the retrieval screen is displayed.

As described above, with the retrieval space mapping system according to the invention, it is possible to retrieve the truly necessary file suitable for the retrieval purposes from not only one or more computers in the organization but also each computer on the internet.

### (4) Others

The invention may be realized by a program code of software for implementing the functions of the embodiments. In this case, a storage medium recording the program code is provided to a system or apparatus, and a computer (or CPU or MPU) in the system or apparatus reads the program code stored in the storage medium. In this case, the program code itself read from the storage medium implements the functions of the embodiments as previously described, and the program code itself and the storage medium storing it may constitute the invention. Examples of the storage medium for supplying the program code may include a floppy disk, CD-ROM, DVD-ROM, a hard disk, an optical disk, a magneto-optical disk, CD-R, a magnetic tape, a non-volatile memory card, and a ROM.

Also, an OS (Operating System) operating on the computer may perform part or all of the actual process based on instructions of the program code and implement the functions of the previous embodiments through the process. Further, after the program code read from the storage medium is written into memory on the computer, the CPU of the computer may perform part or all of the actual process based on instructions of the program code and implement the functions of the previous embodiments through the process.

Also, the program code of software implementing the functions of the embodiments may be distributed via a network, and stored in storage means such as a hard disk or memory for the system or apparatus or a storage medium such as CD-RW or CD-R, and the computer (or CPU or MPU) of the system or apparatus may read and execute the program code stored in the storage means or storage medium when in use.

1. A retrieval system comprising a client terminal, a retrieval space map processing section for providing a retrieval space from a plurality of preset retrieval spaces, said retrieval space defining at least a part of the entire retrieval range, and a retrieval processing section for searching a range defined by said retrieval space in accordance with a retrieval instruction from said client terminal;
wherein said retrieval space map processing section transmits information of a selectable retrieval space to said client terminal by designating the retrieval space that can be searched by the log in user from said plurality of preset retrieval spaces, based on log in information from said client terminal; and
said retrieval processing section performs the retrieval in the retrieval space selected at said client terminal in response to a retrieval instruction.

2. The retrieval system according to claim 1, wherein said retrieval space is defined by limiting said entire retrieval range with at least one of pieces of information including a retrieval purpose, an attribute of retrieval object, a reference authority and a creation period.

3. The retrieval system according to claim 1, further comprising a report file storage section for storing a report file describing the retrieval result in the past, corresponding to each of said plurality of retrieval spaces, wherein said retrieval space map processing section can present said report file corresponding to said selected retrieval space and the retrieval result at the present time in said selected retrieval space to said client terminal by referring to said report file storage means.

4. The retrieval system according to claim 3, wherein said retrieval space map processing section generates a retrieval display screen that can display the retrieval result by switching between said retrieval result at the present time in said selected retrieval space and the retrieval result of said file report and transmits it to said client terminal, and said client terminal displays said retrieval display screen on the screen of a display device, and displays the retrieval result by switching between said retrieval result at the present time and the retrieval result of said file report in response to an instruction of said user.

5. A retrieval space map server apparatus comprising a communication section for communicating with a client terminal, a retrieval space definition file storage section for storing a retrieval space definition file defining a plurality of preset retrieval spaces, the retrieval space defining at least a part of the entire retrieval range, and a retrieval space map processing section for providing a retrieval space from said plurality of retrieval spaces;
wherein said retrieval space map processing section designates the retrieval space that can be searched by the log in user from said plurality of preset retrieval spaces, based on log in information from said client terminal; and
said communication section transmits information of said designated retrieval space as information of the selectable retrieval space to said client terminal, and transmitting the retrieval space selected at said client terminal and the retrieval result from a retrieval processing section for performing the retrieval in response to a retrieval instruction to said client terminal.

6. The retrieval space map server apparatus according to claim 5, further comprising a report file storage section for storing a report file describing the retrieval result in the past, corresponding to each of said plurality of retrieval spaces, wherein said retrieval space map processing section stores the retrieval result at the present time obtained in response to the retrieval instruction from said client terminal as the report file describing the retrieval result corresponding to said selected retrieval space in said report file storage section.

7. The retrieval space map server apparatus according to claim 6, wherein said retrieval space map processing section can present said report file corresponding to said selected retrieval space and the retrieval result at the present time in said selected retrieval space to said client terminal by referring to said report file storage means.

8. A control method for a retrieval system comprising a client terminal, a retrieval space map processing section for providing a retrieval space from a plurality of preset retrieval spaces, the retrieval space defining at least a part of the entire retrieval area, and a retrieval processing section for searching a range defined by said retrieval space in accordance with a retrieval instruction from said client terminal;
selectable retrieval space to said client terminal by designating the retrieval space that can be searched by the log in user from said plurality of preset retrieval spaces, based on log in information from said client terminal; and
said retrieval processing section performs the retrieval in the retrieval space selected at said client terminal in response to said retrieval instruction.

9. A program for causing a plurality of computers to function as the retrieval system according to claim 1.
